(19) United States
(12) Patent Application Publication
(10) Pub. No.: US 2018/0207745 A1
(43) Pub. Date: Jul. 26, 2018

(54) JOINING METHOD AND METHOD FOR MANUFACTURING HEAT SINK

(71) Applicant: NIPPON LIGHT METAL COMPANY, LTD., Tokyo (JP)

(72) Inventors: Hisashi HORI, Shizuoka (JP); Nobushiro SEO, Shizuoka (JP)

(21) Appl. No.: 15/744,707

(22) PCT Filed: Jun. 17, 2016
(86) PCT No.: PCT/JP2016/068074

§ 371 Date: Jan. 12, 2018

(30) Foreign Application Priority Data
Jul. 23, 2015 (JP) 2015-145373
Aug. 7, 2015 (JP) 2015-156616
Aug. 26, 2015 (JP) 2015-166409
Apr. 1, 2016 (JP) 2016-073866

(51) Int. Cl. B23K 20/12

(52) U.S. Cl. CPC B23K 20/125; B23K 20/1265; B23K 20/127

(57) ABSTRACT

The present invention provides a joining method including: a butting step in which a rear face of a first metal member having a recessed groove on its front face is butted against an end face of a second metal member to form a butted portion; and a friction stir step in which a stirring pin of a rotary tool is inserted in the recessed groove so as to be relatively moved therealong for joining the butted portion by friction stir. The diameter of the shoulder portion is set to be smaller than a width of the recessed groove, and in the friction stir step, the butted portion is joined by friction stir in a state that the shoulder portion is spaced from a bottom face of the recessed groove while the shoulder portion holds burrs generated from the first metal member.

### TECHNICAL FIELD

The present invention relates to a joining method for plate-shaped metal members and a method for manufacturing a heat sink.

### BACKGROUND ART

Patent Document 1 discloses a joining method in which a first metal member in a plate shape is butted (pressed) against a second metal member in a plate shape so as to form a T-shape for joining the members. The joining method includes a butting step in which a rear face of the first metal member is butted against an end face of the second metal member to form a butted portion, and a friction stir step in which a rotary tool is pressed from a front face of the first metal member to join the butted portion by friction stir.

Patent Document 2 discloses a joining method in which a first metal member in a plate shape is butted against a second metal member in a plate shape to join the members by friction stir. The joining method includes a butting step in which an end face of the first metal member is butted against an end face of the second metal member to form a butted portion, and a friction stir step in which a rotary tool is pressed from front faces and rear faces of the first and second metal members respectively to join the butted portion by friction stir.

Patent Document 3 discloses a joining method in which a first metal member is overlaid on a second metal member to join the members to each other. The joining method includes an overlaying step in which a rear face of the first metal member is overlaid on a front face of the second metal member to form an overlaid portion, and a friction stir step in which a rotary tool is pressed from a front face of the first metal member to join the overlaid portion by friction stir.

Patent Document 4 discloses a friction stir step in which a pair of heat sink pieces each of which having fins arranged in parallel on one side of a base plate is butted against each other to join the butted portion by friction stir. In the friction stir step, embodiments are disclosed in which a rotary tool is inserted from one side (where the fins are formed) or the other side (where the fins are not formed) of the base plate. In the friction stir step, inserting the rotary tool from said one side of the base plate prevents the burrs from being generated on the other side of the base plate.

### PRIOR ART DOCUMENTS

### Patent Documents

Patent Document 1: Japanese Patent No. 3947271

Patent Document 2: Japanese Patent Application Publication No. 2009-172649

Patent Document 3: Japanese Patent No. 4126966

Patent Document 4: Japanese Patent No. 3336277

### SUMMARY OF THE INVENTION

### Problems to be Solved by the Invention

In the conventional joining methods (Patent Documents 1 and 3), in the friction stir step, a lower end face of a shoulder portion of the rotary tool is pressed against the front face of the first metal member, to have burrs generated on the front face of the first metal member. Accordingly, a burr removing step is needed to remove the burrs. Additionally, the lower end face of the shoulder portion of the rotary tool is pressed against the front face of the first metal member in the friction stir step, to have a problem such that a friction stir device receives a large load.

In addition, in the conventional joining method (Patent Document 2), in the friction stir step, the lower end face of the shoulder portion of the rotary tool is pressed against the front and rear faces of the first and second metal members respectively, to have burrs generated on the front and rear faces. Accordingly, the burr removing step is needed to remove the burrs. Further, the lower end face of the shoulder portion of the rotary tool is pressed against the front and rear faces of the first and second metal members in the friction stir step, to have a problem such that a friction stir device receives a large load.

Further, in the conventional method for manufacturing a heat sink (Patent Document 4), said one side of the base plate provides channels, through which a fluid flows, between the adjacent fins and also provides a channel, through which the fluid flows, between the fins on both sides of the butted portion. Therefore, the burr removing step is needed to remove the burrs generated on said one side of the base plate in the friction stir step, so that the burrs do not interfere with the fluid flowing through the channels. However, on said one side of the base member, the space between the fins on both sides of the butted portion is narrow to have a problem such that it is difficult to carry out the burr removing step.

From such a point of view, the present invention provides a joining method that prevents burrs from being generated on a front face of a first metal member and that reduces a load on a friction stir device.

Further, the present invention provides a joining method that prevents burrs from being generated on front faces of a first metal member and a second metal member and that reduces a load on a friction stir device. Still further, the present invention provides a joining method that prevents burrs from being generated on front and rear faces of a first metal member and a second metal member and that reduces a load on a friction stir device.

Yet further, the present invention provides a method for manufacturing a heat sink that prevents burrs generated in a friction stir step from interfering with a flowing fluid and that reduces a load on a friction stir device.

### Means to Solve the Problems

To solve the problems above, the present invention provides a joining method including: butting a rear face of a first metal member in a plate shape having a recessed groove on a front face against an end face of a second metal member in a plate shape to form a butted portion; and executing friction stir in which a stirring pin of a rotary tool is inserted in the recessed groove from a front face of the first metal member, and the rotary tool is relatively moved along the recessed groove to join the butted portion by friction stir, wherein the rotary tool has a shoulder portion in a cylindrical shape and the stirring pin that extends downward from the shoulder portion, wherein a diameter of the shoulder portion is set to be smaller than a width of the recessed groove, and in the friction stir, the shoulder portion of the rotary tool is inserted in the recessed groove, and the butted portion is joined by friction stir in a state that the shoulder portion is spaced from a bottom face of the recessed groove while the shoulder portion holds a burr generated from the first metal member.

According to the joining method, since a small space is defined by the bottom face of the recessed groove, both side walls of the recessed groove and the lower end face of the shoulder portion, burrs are prevented from scattering and are deposited on the bottom face of the recessed groove. Thus, the generation of the burrs on the front face of the first metal member is prevented. Further, since the shoulder portion is not pressed against the bottom face of the recessed groove, a load applied on a friction stir device is reduced.

The thickness of the second metal member is preferably set to be larger than the width of the recessed groove. According to the joining method, the material of the metal member that is plastically fluidized by the stirring pin of the rotary tool is securely prevented from scattering out of the butted portion between the rear face of the first metal member and the end face of the second metal member in a plate shape.

Further, a present invention provides a joining method of joining metal members to each other by friction stir including: preparing end faces that face an opposed metal member, in which each end face is formed to have an outer end face that is formed on a rear side, an inner end face that is formed on a front side so as to be away from the metal member facing the outer end face, and an intermediate face that is connected with the outer end face and the inner end face; butting the outer end faces of the metal members to form a butted portion so as to form a recessed groove that is formed with the intermediate faces and the inner end faces; and executing friction stir in which a rotary tool is inserted from the front faces of the metal members to join the butted portion by friction stir, wherein the rotary tool has a shoulder portion in a cylindrical shape and a stirring pin that extends downward from the shoulder portion, wherein a diameter of the shoulder portion is set to be smaller than a width of the recessed groove, and in the friction stir, the shoulder portion of the rotary tool is inserted in the recessed groove, and the butted portion is joined by friction stir in a state that the shoulder portion is spaced from a bottom face of the recessed groove while the shoulder portion holds a burr generated from each metal member.

According to the joining method, since a small space is defined by the bottom face of the recessed groove, both side walls of the recessed groove and the lower end face of the shoulder portion, burrs are prevented from scattering and are deposited on the bottom face of the recessed groove. Thus, the generation of the burrs on the front faces of the first and second metal members is prevented. Further, since the shoulder portion is not pressed against the bottom face of the recessed groove, a load applied on a friction stir device is reduced.

Further, a present invention provides a joining method of joining metal members to each other by friction stir including: preparing end faces that face an opposed metal member, in which each end face is formed to have an outer end face that is formed at a center in a thickness direction, a pair of inner end faces that is formed on a front side and a rear side with respect to the outer end face so as to be away from the metal member facing the outer end face, and a pair of intermediate faces that is connected with the outer end face and the pair of inner end faces respectively; butting the outer end faces of the metal members against each other to form a butted portion so as to form a pair of recessed grooves that is formed with the intermediate faces and the inner end faces respectively formed on the front sides and the rear sides of the metal members; executing first friction stir in which a rotary tool is inserted from the front faces of the metal members to join the butted portion by friction stir; and executing second friction stir in which the rotary tool is inserted from the rear faces of the metal members to join the butted portion by friction stir, wherein the rotary tool has a shoulder portion in a cylindrical shape and a stirring pin that extends downward from the shoulder portion, wherein a diameter of the shoulder portion is set to be smaller than a width of the recessed grooves, and in the first friction stir and the second friction stir, the shoulder portion of the rotary tool is respectively inserted in the recessed grooves, and the butted portion is joined by friction stir in a state that the shoulder portion is spaced from bottom faces of the recessed grooves while the shoulder portion holds a burr generated from each metal member.

According to the joining method, since a small space is defined by the bottom face and both side walls of each recessed groove and the lower end face of the shoulder portion, burrs are prevented from scattering and are deposited on the bottom face of each recessed groove. Thus, the generation of the burrs on the front faces and rear faces of the first and second metal members is prevented. Further, since the shoulder portion is not pressed against the bottom face of the recessed groove, a load applied on a friction stir device is reduced.

Further, a plasticized region formed in the first friction stir is preferably overlapped with that formed in the second friction stir.

According to the joining method, since the butted portion is frictionally stirred over the entire length in the depth direction, joining strength, water-tightness and air-tightness are improved.

Further, the joining method preferably further includes: arranging tab members at both ends of the butted portion respectively, wherein, in the friction stir, a start position for friction stir is set in one tab member and an end position for friction stir is set in the other tab member.

According to the joining method, the start and end positions for friction stir are easily set and the side faces of the metal members are nicely formed.

Further, a present invention provides a joining method including: overlaying a rear face of a first metal member that is formed with a recessed groove in a front face with a front face of a second metal member to form an overlaid portion; and executing friction stir in which a stirring pin of a rotary tool is inserted in the recessed groove from a front side of the first metal member, and the rotary tool is relatively moved in the recessed groove to join the overlaid portion by friction stir, wherein the rotary tool has a shoulder portion in a cylindrical shape and the stirring pin that extends downward from the shoulder portion, wherein a diameter of the shoulder portion is set to be smaller than a width of the recessed groove, and in the friction stir, the shoulder portion of the rotary tool is inserted in the recessed groove, and the overlaid portion is joined by friction stir in a state that the shoulder portion is spaced from a bottom face of the recessed groove while the shoulder portion holds a burr generated from the first metal member.

Further, a present invention provides a joining method including: overlaying a rear face of a first metal member that is formed with a recessed groove in a front face with a front face of a second metal member to form an overlaid portion; and executing friction stir in which a stirring pin of a rotary tool is inserted in the recessed groove from a front side of the first metal member, and the rotary tool is relatively moved in the recessed groove to join the overlaid portion by friction stir, wherein the recessed groove is formed to be a closed loop, the rotary tool has a shoulder portion in a cylindrical shape and the stirring pin that extends downward from the shoulder portion, wherein a diameter of the shoulder portion is set to be smaller than a width of the recessed groove, and in the friction stir, the shoulder portion of the rotary tool is inserted in the recessed groove, and the overlaid portion is joined by friction stir in a state that the shoulder portion is spaced from a bottom face of the recessed groove while the shoulder portion holds a burr generated from the first metal member. Further, in the friction stir, the rotary tool is preferably moved along the entire recessed groove to join the overlaid portion by friction stir.

According to the joining method, since a small space is defined by the bottom face of the recessed groove, both side walls of the recessed groove and the lower end face of the shoulder portion, burrs are prevented from scattering and are deposited on the bottom face of the recessed groove. Thus, the generation of the burrs on the front face of the first metal member is prevented. Further, since the shoulder portion is not pressed against the bottom face of the recessed groove, a load applied on a friction stir device is reduced.

Further, a present invention provides a method for manufacturing a heat sink including: grooving in which a multi-cutter having a plurality of disc cutters in parallel is rotated to relatively move in a machined metal member having a base member and a machined block that is arranged on a front face of the base member and is in a rectangular parallelepiped shape to form a heat sink piece having a plurality of fins and grooves; butting lateral end faces of the base members of at least two heat sink pieces against each other to form a butted portion; and executing friction stir in which a rotary tool having a shoulder portion in a cylindrical shape and a stirring pin that extends downward from the shoulder portion is relatively moved along the butted portion to join the butted portion by friction stir, wherein a diameter of the shoulder portion is set to be smaller than a width of a space between groups of fins of the adjacent heat sink pieces, and in the friction stir, the stirring pin of the rotary tool is inserted in the butted portion, and the butted portion is joined by friction stir in a state that the shoulder portion is spaced from a front face of the base member while the shoulder portion holds a burr generated from the base member.

According to the manufacturing method, in the friction stir, since a small space is defined by the fins formed on the both sides of the butted portion and the lower end face of the shoulder portion, burrs are prevented from scattering and are deposited on the front faces of the base members. Thus, it is possible to inhibit the burrs from blocking the flowing fluid. Further, since the shoulder portion of the rotary tool is not pressed against the front faces of the base members, a load applied on the friction stir device is reduced. Still further, since the fins are formed with the multi-cutter, the thickness of the fin, a distance between the fins and the like are easily changed.

Further, in the friction stir, a distance between the shoulder portion and the front face of the base member is preferably set to be smaller than that between a bottom face of the groove and the front face of the base member. According to the manufacturing method, it is possible to further inhibit the burrs from blocking the flowing fluid.

Further, the manufacturing method preferably further includes arranging a pair of tab members at both ends of the butted portion, wherein in the friction stir, a start position for friction stir is set in one tab member and an end position for friction stir is set in the other tab member.

According to the manufacturing method, the start position where the rotary tool is inserted and the end position are easily set. Further, the butted portion is joined by friction stir over the entire length and the lateral end faces of the base members are nicely finished.

Further, in the butting, the heat sink pieces are preferably butted so that an orientation of the fins of one heat sink piece is in parallel to that of the fins of another heat sink piece. Alternatively, in the butting, the heat sink pieces are preferably butted so that an orientation of the fins of one heat sink piece is different from that of the fins of another heat sink piece.

According to the manufacturing method, the variation of the flow channel where the fluid flows is increased.

### Advantageous Effects of the Invention

The joining method according to the present invention prevents the burrs from being generated on the front face of the first metal member and reduces the load on the friction stir device.

Further, the joining method according to the present invention prevents the burrs from being generated on the front faces of the first and second metal members and reduces the load on the friction stir device. Still further, the joining method according to the present invention prevents the burrs from being generated on the front and rear faces of the first and second metal members and reduces the load on the friction stir device.

Yet further, the method for manufacturing a heat sink according to the present invention prevents the burrs generated in the friction stir step from interfering with the flowing fluid and reduces the load on the friction stir device.

### BRIEF DESCRIPTION OF THE DRAWINGS

FIG. 1 is a perspective view showing a butting step of a joining method according to a first embodiment of the present invention;

FIG. 2A perspectively illustrates and FIG. 2B cross-sectionally illustrates a friction stir step in the joining method according to the first embodiment;

FIG. 3 is a cross-sectional view showing a state after the friction stir step in the joining method according to the first embodiment;

FIG. 4 is a cross-sectional view of a modification of the joining method according to the first embodiment;

FIG. 5 is a cross-sectional view showing a butting step in a joining method according to a second embodiment of the present invention;

FIG. 6A is a cross-sectional view showing a first friction stir step and FIG. 6B is a cross-sectional view showing a second friction stir step, in the joining method according to the second embodiment;

FIG. 7A is a perspective view showing a preparing step and FIG. 7B is a cross-sectional view showing a butting step, in a joining step according to a third embodiment of the present invention;

FIG. 8A is a perspective view showing a tab member arranging step and FIG. 8B is a perspective view showing a friction stir step, in the joining method according to the third embodiment;

FIG. 9 is a schematic cross-sectional view showing the friction stir step in the joining method according to the third embodiment;

FIG. 10A is a cross-sectional view showing a preparing step and FIG. 10B is a cross-sectional view showing a butting step, in a joining method according to a fourth embodiment of the present invention;

FIG. 11A is a perspective view and FIG. 11B is a schematic cross-sectional view of a first friction stir step according to the fourth embodiment;

FIG. 12 is a schematic cross-sectional view of a second friction stir step according to the fourth embodiment;

FIG. 13 is a perspective view showing an overlaying step in a joining method according to a fifth embodiment of the present invention;

FIG. 14 is a perspective view showing a friction stir step in the joining step according to the fifth embodiment;

FIG. 15 is a cross-sectional view showing the friction stir step in the joining step according to the fifth embodiment;

FIG. 16 is a perspective view showing an overlaying step in a joining method according to a sixth embodiment of the present invention;

FIG. 17 is a plan view showing a friction stir step in the joining step according to the sixth embodiment;

FIG. 18 is a perspective view of a heat sink according to a seventh embodiment of the present invention;

FIG. 19 is a cross-sectional view of main parts of the heat sink according to the seventh embodiment;

FIG. 20 is a perspective view showing a groove forming step in a method for manufacturing a heat sink according to the seventh embodiment;

FIG. 21 is a schematic side view showing a groove forming step in the method for manufacturing a heat sink according to the seventh embodiment;

FIG. 22 is a perspective view of a heat sink piece according to the seventh embodiment;

FIG. 23 is a cross-sectional view showing a butting step in the method for manufacturing a heat sink according to the seventh embodiment;

FIG. 24 is a perspective view showing a tab member arranging step in the method for manufacturing a heat sink according to the seventh embodiment;

FIG. 25 is a perspective view showing a friction stir step in the method for manufacturing a heat sink according to the seventh embodiment;

FIG. 26 is a cross-sectional view showing the friction stir step in the method for manufacturing a heat sink according to the seventh embodiment;

FIG. 27 is a plan view showing the friction stir step in the method for manufacturing a heat sink according to the seventh embodiment; and

FIG. 28 is a plan view showing a modification of the heat sink according to the seventh embodiment.

### EMBODIMENTS OF THE INVENTION

### First Embodiment

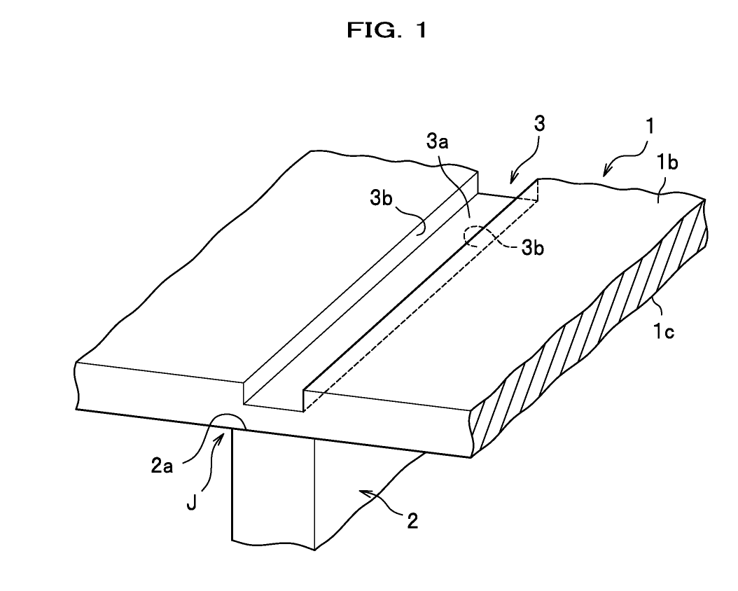

A joining method according to a first embodiment of the present invention will be described in detail with reference to the drawings. As shown in FIG. 1, in the joining method according to the first embodiment, a first metal member 1 is butted (pressed) against and joined to a second metal member 2 so as to form a T-shape. The joining method according to the first embodiment includes a butting step and a friction stir step. Note that a “front face” in the description is meant to be an opposite face with respect to a “rear face”.

The first metal member 1 is a plate-shaped metal member. The material of the first metal member 1 is appropriately selected from frictionally stirrable metals such as aluminum, aluminum alloy, copper, copper alloy, titanium, titanium alloy, magnesium, and magnesium alloy. A recessed groove 3 having a rectangular shape in cross-section is formed in the front face of the first metal member 1. The recessed groove 3 extends in a longitudinal direction of the first metal member 1. The second metal member 2 is a plate-shaped metal member. The thickness of the second metal member 2 may be set appropriately, and in the present embodiment, is set larger than the width of the recessed groove 3. The material of the second metal member 2 may be appropriately selected from the frictionally stirrable metals described above, and is preferably the same material as that of the first metal member 1.

In the butting step, as shown in FIG. 1, a rear face 1c of the first metal member 1 is butted against an end face 2a of the second metal member 2 so as to form a T-shape in front view. In the butting step, the end face 2a of the second metal member 2 is butted against a corresponding position of the recessed groove 3. A butted portion J is formed by butting the rear face 1c of the first metal member 1 against the end face 2a of the second metal member 2.

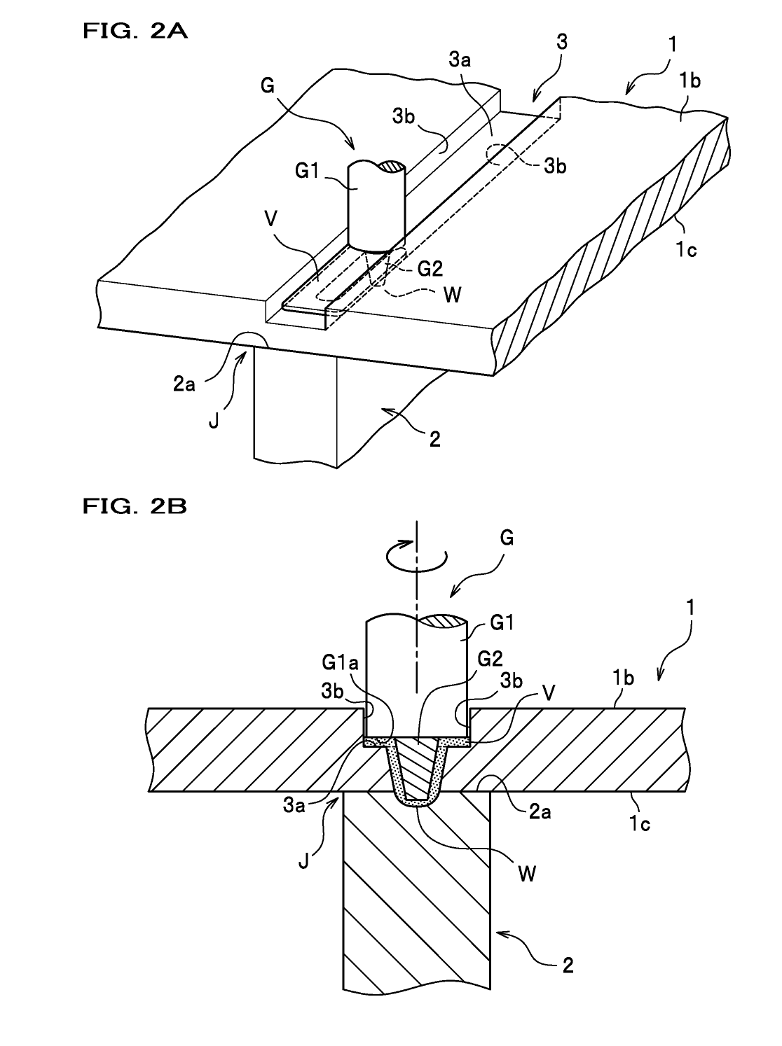

In a friction stir step, as shown in FIGS. 2A and 2B, a shoulder portion G1 of a rotary tool G is inserted in the recessed groove 3 to join the butted portion J by friction stir. The rotary tool G has the shoulder portion G1 in a cylindrical shape and a stirring pin G2 extending downward from a lower end face G1a of the shoulder portion G1. The outer diameter of the shoulder portion G1 is slightly smaller than the width of the recessed groove 3. Though the outer diameter of the shoulder portion G1 may be set such that the outer peripheral face of the shoulder portion G1 contacts side walls 3b of the recessed groove 3, it is preferably set such that the rotary tool G is relatively movable in the recessed groove 3 with a small gap between the outer peripheral face of the shoulder portion G1 and the side walls 3b of the recessed groove 3 during the friction stir step.

The stirring pin G2 is tapered. A spiral groove is formed in the outer peripheral face of the stirring pin G2. In the present embodiment, since the rotary tool G is rotated clockwise, the spiral groove in the stirring pin G2 is formed counterclockwise from the base end toward the distal end. In other words, the spiral groove is traced from the base end toward the distal end to find that it is formed counterclockwise as seen from above.

Note that, in a case where the rotary tool G is rotated counterclockwise, the spiral groove is preferably formed clockwise from the base end toward the distal end. In other words, the spiral groove in this case is traced from the base end toward the distal end to find that it is formed clockwise as seen from above. The spiral groove formed in this way allows a plastically fluidized metal to be guided toward the distal end of the stirring pin G2 via the spiral groove during the friction stir step. This reduces the amount of metal spilling out of a bottom face 3a of the recessed groove 3.

In the friction stir step, the stirring pin G2 of the rotary tool G is inserted into the center of the bottom face 3a of the recessed groove 3 from the front face 1b of the first metal member 1, and the rotary tool G is relatively moved along the butted portion J (recessed groove 3). The depth of the inserted rotary tool G may be appropriately set, and in the present embodiment, is set such that the stirring pin G2 reaches the second metal member 2. Accordingly, the friction stir joining is carried out in a state that the stirring pin G2 contacts the first metal member 1 and the second metal member 2. A plasticized region W is formed on a movement track of the rotary tool G.

Further, in the friction stir step, the lower end face G1a of the shoulder portion G1 is spaced from the bottom face 3a of the recessed groove 3 and is set at a position lower than the front face 1b of the first metal member 1. That is, in the friction stir step, the friction stir joining is carried out while the burrs V generated by friction stir is held under the lower end face G1a of the shoulder portion G1. The phrase in the appended claims, “a state that the shoulder portion is spaced from a bottom face of the recessed groove” means that the lower end face G1a of the shoulder portion G1 is spaced from the bottom face 3a of the recessed groove 3 before the burrs V are generated. Further, the phrase in the appended claims, “while the shoulder portion holds a burr generated from the first metal member” means that the deposited burrs V are in contact with the lower end face G1a of the shoulder portion G1 and the front face (upper face) of the burrs V is held under the lower end face G1a of the shoulder portion G1.

Further, the outer peripheral surface of the shoulder portion G1 is spaced from the side walls 3b of the recessed groove 3 by a small gap. A small space is defined by the bottom face 3a of the recessed groove 3, the side walls 3b of the recessed groove 3, and the lower end face G1a of the shoulder portion G1.

Note that the stirring pin G2 may be set so as not to reach the second metal member 2. That is, in the friction stir step, the insertion depth may be set for the stirring pin G2 such that the stirring pin G2 only contacts the first metal member 1. Thus, in the case where the tip of the stirring pin G2 is set not to reach the second metal member 2, friction heat between the first metal member 1 and the stirring pin G2 plastically fluidizes the metal around the butted portion J to join the first metal member 1 with the second metal member 2.

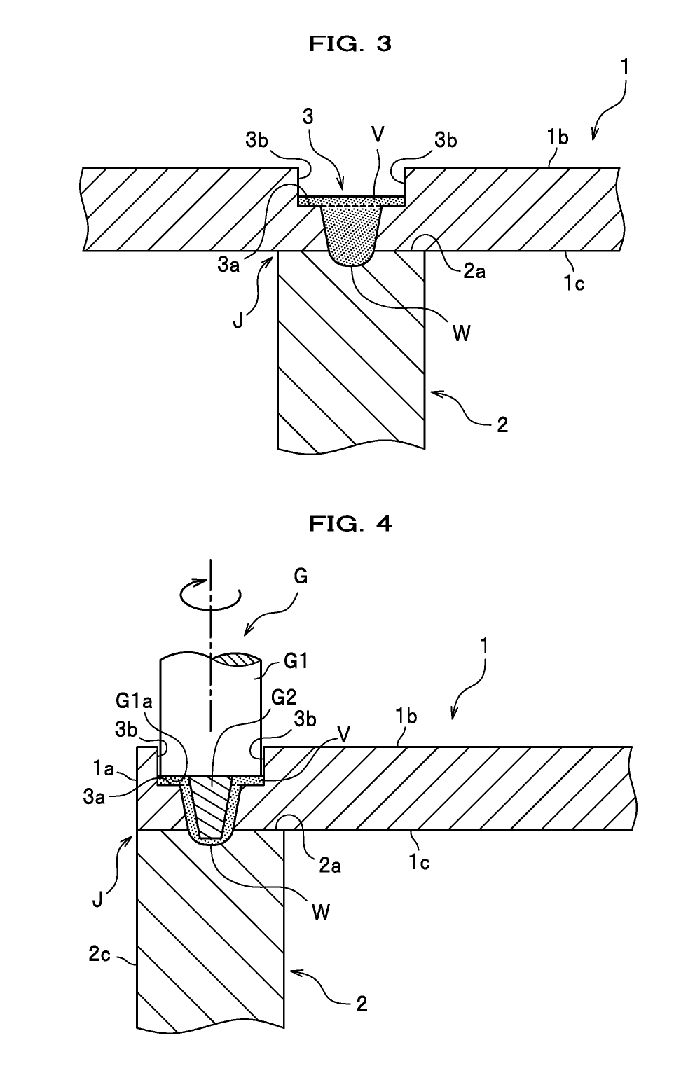

Though the burrs V are generated on the bottom face 3a of the recessed groove 3 in the friction stir step, the burrs V are confined in the small space (rectangular closed space in cross-section) defined by the bottom face 3a of the recessed groove 3, the side walls 3b of the recessed groove 3, and the lower end face G1a of the shoulder portion G1, and the burrs V are deposited on the bottom face 3a. As shown in FIG. 3, the burrs V are deposited in the recessed groove 3 and the front face (upper face) of the burrs V is held under the lower end face G1a of the shoulder portion G1 to have an approximately flat shape.

According to the joining method of the present embodiment described above, since the small space is defined by the bottom face 3a of the recessed groove 3, the side walls 3b of the recessed groove 3 and the lower end face G1a of the shoulder portion G1 during the friction stir step, the burrs V are prevented from scattering and are deposited on the bottom face 3a of the recessed groove 3. Thus, the generation of the burrs V on the front face 1b of the first metal member 1 is prevented. Accordingly, a surface treatment such as a burr removing step for the front face 1b of the first metal member 1 is omitted.

Further, according to the joining method of the present embodiment, since the shoulder portion G1 is not pressed against the bottom face 3a of the recessed groove 3, a load applied on the friction stir device is reduced. Further, in the present embodiment, since the thickness of the second metal member 2 is set to be larger than the width of the recessed groove 3, a material that is plastically fluidized with the stirring pin G2 of the rotary tool G is reliably prevented from scattering out of the butted portion J between the rear face 1c of the first metal member 1 and the end face 2a of the plate-shaped metal member 2.

Note that, before the friction stir step, a welding step may be carried out on inner corners between the first metal member 1 and the second metal member 2. After the welding step, the friction stir joining is stably carried out.

### Modification

FIG. 4 is a cross-sectional view showing a modification of the joining method according to the first embodiment. As shown in FIG. 4, the first metal member 1 may be butted against the second metal member 2 so as to form an L-shape in front view. That is, in a butting step according to the modification, the rear face 1c of the first metal member 1 is butted against the end face 2a of the second metal member 2 so that an end face 1a of the first metal member 1 is flush with a side face 2c of the second metal member 2. Since the modification is approximately the same as the first embodiment except the butting step, a detailed description thereof is omitted. The modification also allows for gaining the same advantageous effects as the first embodiment.

### Second Embodiment

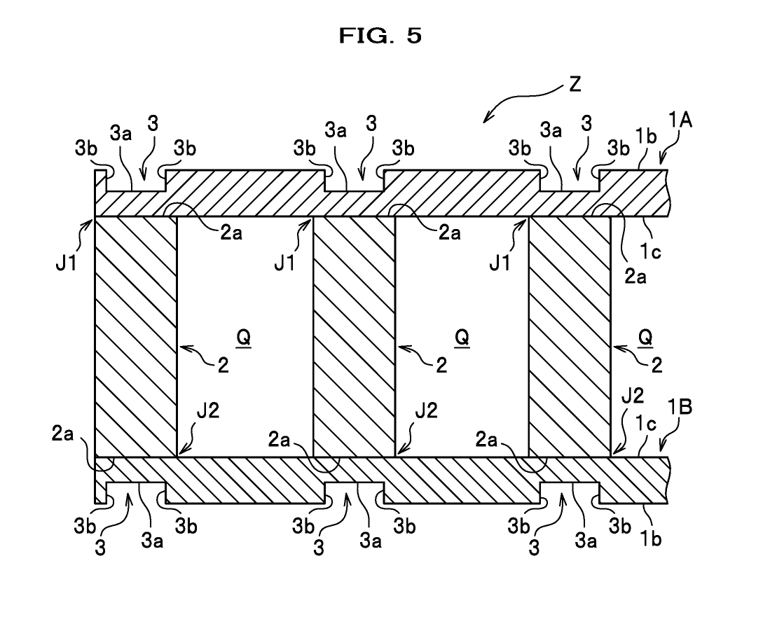

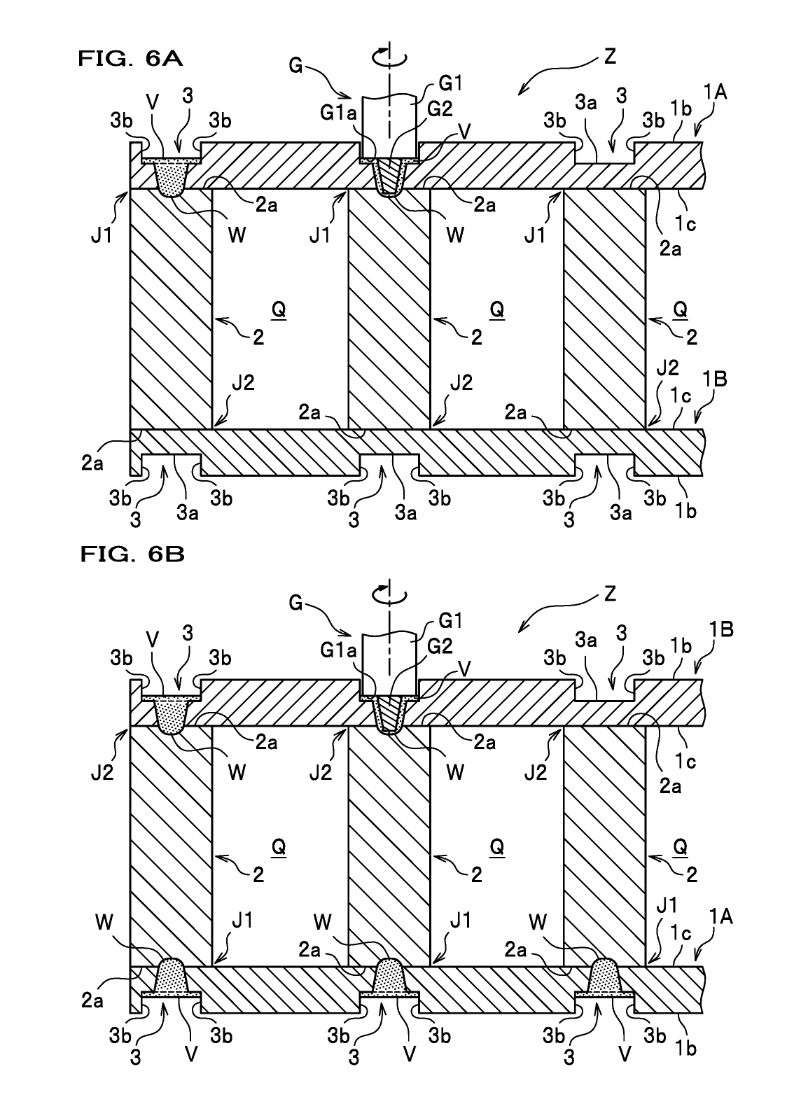

Next, a description will be given of a joining method according to a second embodiment of the present invention. As shown in FIGS. 5 and 6, in the joining method according to the second embodiment, a structure Z is formed by joining a pair of first metal members 1 (1A, 1B) with a plurality of second metal members 2.

The first metal member 1A is a plate-shaped metal member. A plurality of recessed grooves 3 are formed on the front face 1b of the first metal member 1A. The recessed grooves 3 are formed at predetermined intervals. The first metal member 1B is the same as the first metal member 1A. The joining method according to the second embodiment includes a butting step and a friction stir step.

In the butting step, the first metal members 1A, 1B are butted against the second metal members 2 to form a plurality of butted portions J1, J2. In the butting step, the rear face 1c of the first metal member 1A is butted against one end face 2a of each second metal member 2 to form the butted portions J1. Said one end face 2a of the second metal member 2 is butted against the first metal member 1A at a position corresponding to the recessed groove 3. Further, in the butting step, the rear face 1c of the first metal member 1B is butted against the other end face 2a of each second metal member 2 to form the butted portions J2. Said other end face 2a of the second metal member 2 is butted against the first metal member 1B at a position corresponding to the recessed groove 3.

The friction stir step includes a first friction stir step in which the butted portion J1 formed with the first metal member 1A and the second metal member 2 is joined, and a second friction stir step in which the butted portion J2 formed with the first metal member 1B and the second metal member 2 is joined. As shown in FIG. 6A, the butted portions J1 are joined by friction stir with the use of the rotary tool G in the first friction stir step. Since the first friction stir step is the same as the friction stir step in the first embodiment, a detailed description thereof is omitted. Further, as shown in FIG. 6B, the butted portions J2 are joined by friction stir with the use of the rotary tool G in the second friction stir step. Since the second friction stir step is the same as the friction stir step in the first embodiment, a detailed description thereof is omitted.

According to the joining method of the second embodiment, the structure Z having therein a plurality of hollow portions Q in a cross-sectionally rectangular shape is formed. Further, according to the joining method of the second embodiment, since a small space is defined by the bottom face 3a of the recessed groove 3, the side walls 3b of the recessed groove 3, and the lower end face G1a of the shoulder portion G1, the burrs V are prevented from scattering and are deposited on the bottom face 3a of the recessed groove 3. This prevents the burrs V from being generated on the front faces 1b of the first metal members 1A, 1B. Further, according to the joining method of the present embodiment, since the shoulder portion G1 is not pressed against the bottom face 3a of the recessed groove 3, the load applied on the friction stir device is reduced.

### Third Embodiment

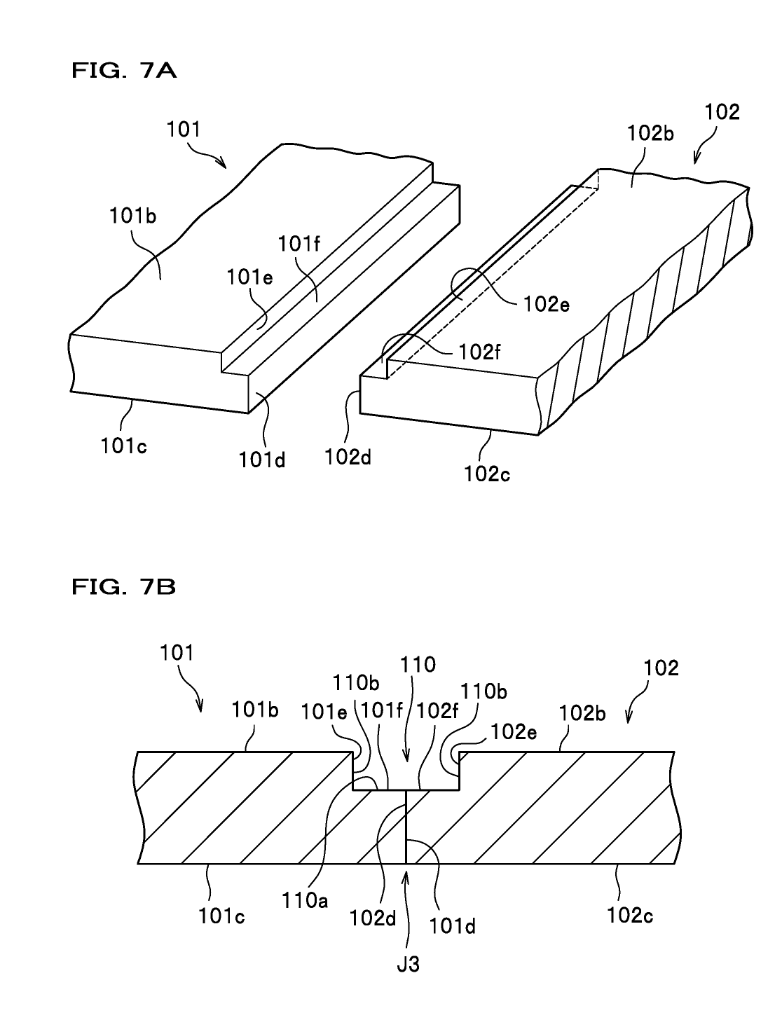

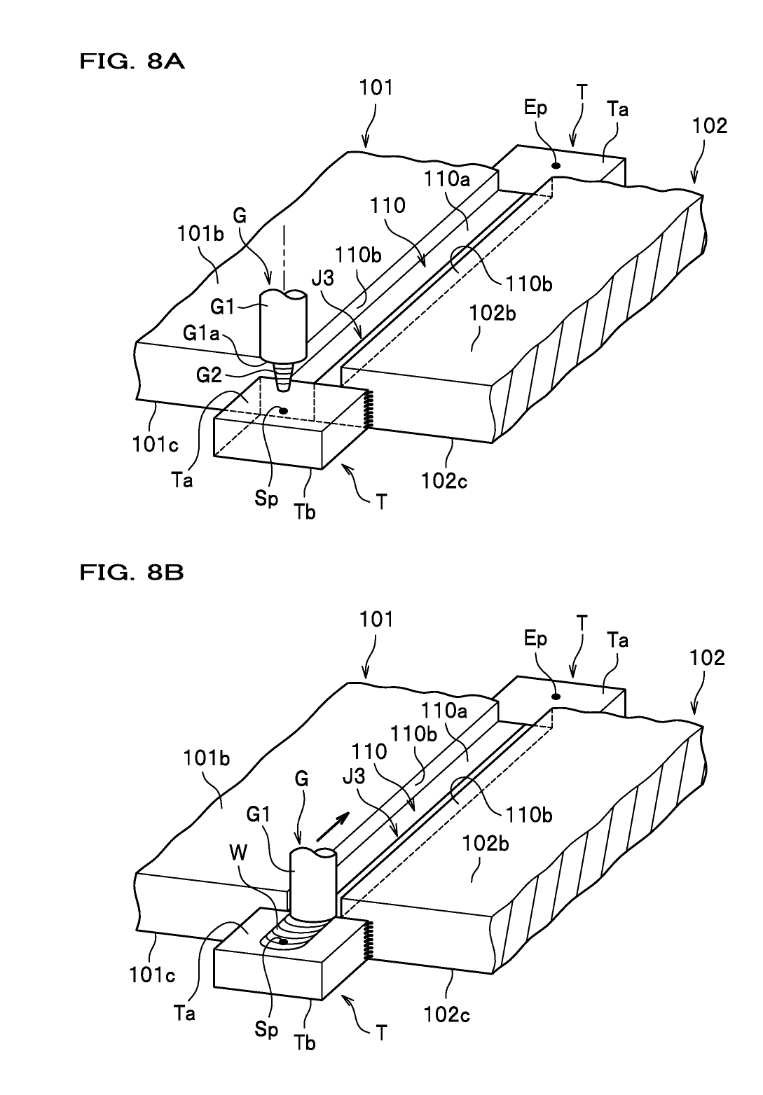

A description will be given of a joining method according to a third embodiment of the invention in detail with reference to the drawings. As shown in FIGS. 7A and 7B, in the joining method according to the third embodiment, the first metal member 101 is butted against the second metal member 102 for joining. The joining method according to the third embodiment includes a preparing step, a butting step, a tab member arranging step and a friction stir step.

In the preparing step, as shown in FIG. 7A, a first metal member 101 and a second metal member 102 are prepared. The first metal member 101 is a plate-shaped metal member. The material of the first metal member 101 is appropriately selected from frictionally stirrable metals such as aluminum, aluminum alloy, copper, copper alloy, titanium, titanium alloy, magnesium, and magnesium alloy. In the preparing step, the end face of the first metal member 101 is formed to have an outer end face 101d, an inner end face 101e and an intermediate face 101f. The inner end face 101e is formed so as to be away from the second metal member 102 that faces the outer end face 101d. The intermediate face 101f is connected with the outer end face 101d and the inner end face 101e, and is orthogonal thereto. The inner end face 101e and the intermediate face 101f of the first metal member 101 may be formed by cutting the end face or may be pre-molded by die-casting.

The second metal member 102 is a plate-shaped metal member. The material of the second metal member 102 may be appropriately selected from the friction stirrable metals described above, and is preferably the same material as the first metal member 101. The second metal member 102 is formed in the same shape as the first metal member 101. That is, in the preparing step, the end face of the second metal member 102 is defined by an outer end face 102d, an inner end face 102e and an intermediate surface 102f. The inner end face 102e is formed so as to be away from the first metal member 101 that faces the outer end face 102d. The intermediate face 102f is connected with the outer end face 102d and the inner end face 102e and is orthogonal thereto.

In the butting step, as shown in FIG. 7B, the end face of the first metal member 101 is butted against the end face of the second metal member 102 to form a butted portion J3. In the butting step, the outer end face 101d of the first metal member 101 is butted against the outer end face 102d of the second metal member 102. Thus, the butted portion J3 is formed. Further, a recessed groove 110 is defined by the facing inner end faces 101e, 102e and the continuing intermediate faces 101f, 102f. The recessed groove 110 is in a cross-sectionally rectangular shape. The recessed groove 110 is defined by a bottom face 110a (intermediate faces 101f, 102f) and the side walls 110b (inner end faces 101e, 102e).

In the tab member arranging step, as shown in FIG. 8A, a pair of tab members T is arranged at both ends of the butted portion J3. The tab member T is in a rectangular parallelepiped shape and is formed of the same material as the first and second metal members 101, 102. The thickness of the tab member T is formed to be the same as the height of the outer end faces 101d, 102d. In the tab member arranging step, the side face of the tab member T is brought into contact with the side faces of the first and second metal members 101, 102 to temporarily weld the inner corner between the first metal member 101 and the tab member T and the inner corner between the second metal member 102 and the tab member T. A front face Ta of the tab member T is made flush with the bottom face 110a of the recessed groove 110 and a rear face Tb of the tab member T is made flush with a rear face 101c of the first metal member 101 and a rear face 102c of the second metal member 102.

In the friction stir step, as shown in FIGS. 8A and 8B, the shoulder portion G1 of the rotary tool G is inserted in the recessed groove 110 to join the butted portion J3 by friction stir. The rotary tool G has the shoulder portion G1 in a cylindrical shape and the stirring pin G2 extending downward from the lower end face G1a of the shoulder portion G1. The diameter of the shoulder portion G1 is slightly smaller than the width of the recessed groove 110. The diameter of the shoulder portion G1 may be set such that the outer peripheral face of the shoulder portion G1 is in contact with the side walls 110b of the recessed groove 110. However, the diameter of the shoulder portion G1 is preferably set such that, during the friction stir step, the rotary tool G is relatively movable with a small gap between the outer peripheral face of the shoulder portion G1 and the side walls 110b of the recessed groove 110.

The stirring pin G2 is tapered. The spiral groove is formed in the outer peripheral face of the stirring pin G2. In the present embodiment, since the rotary tool G is rotated clockwise, the spiral groove of the stirring pin G2 is formed counterclockwise from the base end toward the distal end. In other words, the spiral groove is traced from the base end toward the distal end to find that it is formed counterclockwise as seen from above.

Note that, in a case where the rotary tool G is rotated counterclockwise, the spiral groove is preferably formed clockwise from the base end toward the distal end. In other words, the spiral groove in this case is traced from the base end toward the distal end to find that it is formed clockwise as seen from above. The spiral groove formed in this way allows a plastically fluidized metal to be guided toward the distal end of the stirring pin G2 via the spiral groove during the friction stir step. This reduces the amount of metal spilling out of the bottom face 110a of the recessed groove 110.

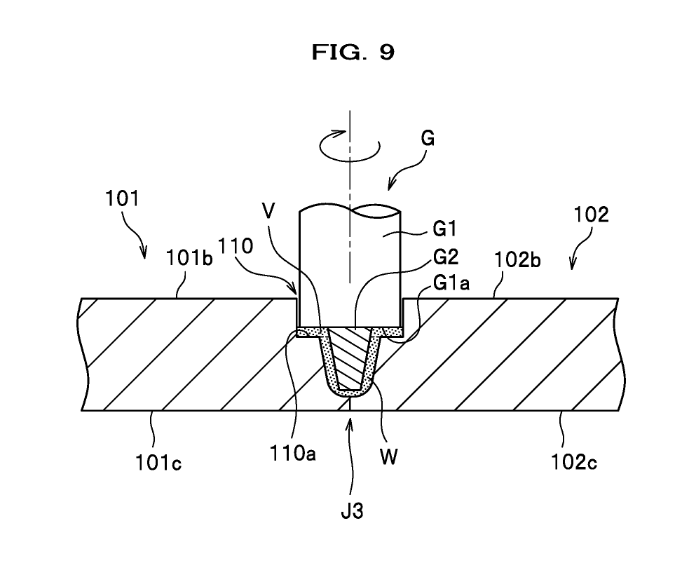

In the friction stir step, as shown in FIG. 8B, the stirring pin G2 of the rotary tool G is firstly inserted in a start position Sp set in the front face Ta of one tab member T, and then, the lower end face G1a is butted against the front face Ta so that the rotary tool G is relatively moved toward the butted portion J3. When the rotary tool G comes to the butted portion J3, as shown in FIG. 9, the rotary tool G is relatively moved along the butted portion J3 (recessed groove 110), while the lower end face G1a is spaced apart from the bottom face 110a of the recessed groove 110. The plasticized region W is formed on the movement track of the rotary tool G.

In the friction stir step, the lower end face G1a of the shoulder portion G1 is spaced from the bottom face 110a of the recessed groove 110 and is set at a position lower than the front face 101b of the first metal member 101. That is, in the friction stir step, the friction stir joining is carried out while the burrs V generated by friction stir is held under the lower end face G1a of the shoulder portion G1. The phrase in the appended claims, “a state that the shoulder portion is spaced from a bottom face of the recessed groove” means that the lower end face G1a of the shoulder portion G1 is spaced from the bottom face 110a of the recessed groove 110 before the burrs V are generated. Further, the phrase in the appended claims, “while the shoulder portion holds a burr generated from each metal member” means that the deposited burrs V are in contact with the lower end face G1a of the shoulder portion G1 and the front face (upper face) of the burrs V is held under the lower end face G1a of the shoulder portion G1.

Further, the outer peripheral surface of the shoulder portion G1 is spaced from the side walls 110b of the recessed groove 110 by a small gap. A small space is defined by the bottom face 110a of the recessed groove 110, the side walls 110b of the recessed groove 110, and the lower end face G1a of the shoulder portion G1.

Though the burrs V are generated on the bottom face 110a of the recessed groove 110 in the friction stir step, the burrs V are confined in the small space (rectangular closed space in cross-section) defined by the bottom face 110a of the recessed groove 110, the side walls 110b of the recessed groove 110, and the lower end face G1a of the shoulder portion G1, and the burrs V are deposited on the bottom face 110a. As shown in FIG. 9, the burrs V are deposited in the recessed groove 110 and the front face (upper face) of the burrs V is held to have an approximately flat shape under the lower end face G1a of the shoulder portion G1. When the rotary tool G reaches an end position Ep that is set in the front face Ta of the other tab member T, the rotary tool G is set apart from the tab member T. Then, the tab members T are cut off from the first and second metal members 101, 102.

According to the joining method of the present embodiment described above, since the small space is defined by the bottom face 110a of the recessed groove 110, the side walls 110b of the recessed groove 110 and the lower end face G1a of the shoulder portion G1 during the friction stir step, the burrs V are prevented from scattering and are deposited on the bottom face 110a of the recessed groove 110. This prevents the burrs V from being generated on the front face 101b of the first metal member 101 and the front face 102b of the second metal member 102. Accordingly, a surface treatment such as a burr removing step for the front face 101b of the first metal member 101 and the front face 102b of the second metal member 102 is omitted.

Further, according to the joining method of the present embodiment, since the shoulder portion G1 is not pressed against the bottom face 110a of the recessed groove 110, a load applied on the friction stir device is reduced. Still further, the friction stir step is carried out with the use of the pair of tab members T so that it is easy to set the start position Sp and the end position Ep for the friction stir step. Accordingly, the side faces of the first and second metal members 101, 102 are nicely finished.

### Fourth Embodiment

Next, a description will be given of a joining method according to a fourth embodiment of the present invention. In the joining method according to the fourth embodiment differs from the third embodiment in that the front and rear faces of a first metal member 101A and a second metal member 102A are joined by friction stir. In the description of the fourth embodiment, portions common to those of the third embodiment will be omitted.

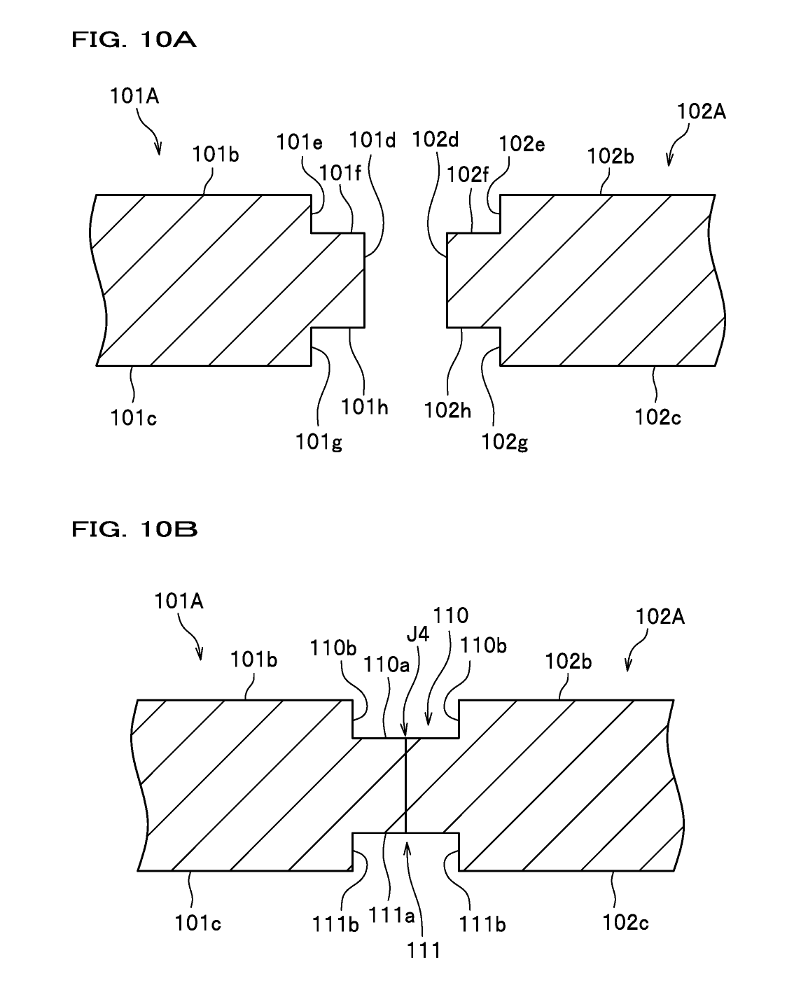

The joining method according to the fourth embodiment includes a preparing step, a butting step, a tab member arranging step, a first friction stir step and a second friction stir step. In the preparing step, as shown in FIG. 10A, the end face of the first metal member 101A is defined by an outer end face 101d, an inner end face 101e, an intermediate face 101f, an inner end face 101g and an intermediate surface 101h. The inner end face 101g is formed on a rear side of the outer end face 101d, so as to be away from the facing second metal member 102A. The intermediate face 101h is connected with the outer end face 101d and the inner end face 101g and is orthogonal thereto. In other words, the inner end face 101e and the intermediate face 101f are formed on a side closer to the front face 101b of the first metal member 101A, and the inner end face 101g and the intermediate face 101h are formed on a side closer to the rear face 101c of the first metal member 101A.

The second metal member 102A is formed to have the same shape as the first metal member 101A. That is, in the preparing step, the end face of the second metal member 102A is defined by an outer end face 102d, an inner end face 102e, an intermediate face 102f, an inner end face 102g and an intermediate face 102h. The inner end face 102g is formed on the side away from the first metal member 101A facing the outer end face 102d. The intermediate face 102h is connected with the outer end face 102d and the inner end face 102g and is orthogonal thereto. In other words, the inner end face 102e and the intermediate face 102f are formed on the front face 102b of the second metal member 102A, and the inner end face 102g and the intermediate face 102h are formed on a rear face 102c of the second metal member 102A.

In the butting step, as shown in FIGS. 10A and 10B, the end face of the first metal member 101A is butted against the end face of the second metal member 102A to form a butted portion J4. In the butting step, the outer end face 101d of the first metal member 101A is butted against the outer end face 102d of the second metal member 102A. This forms the butted portion J4. Further, the recessed groove 110 is defined by the facing inner end faces 101e, 102e and the continuing intermediate faces 101f, 102f. In addition, a recessed groove 111 is defined by the facing inner end faces 101g, 102g and the continuing intermediate faces 101h, 102h. The recessed groove 111 is in a rectangular shape in cross-section. The recessed groove 111 is defined by a bottom face 111a (intermediate faces 101h, 102h) and side walls 111b (inner end faces 101g, 102g).

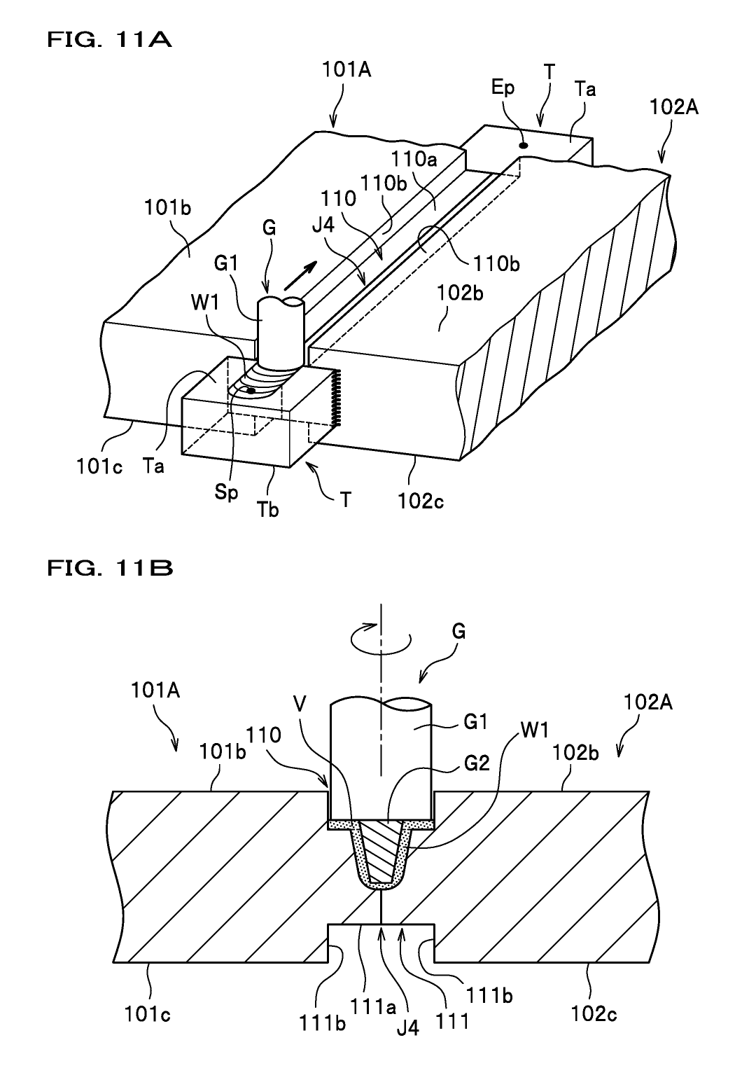

In the tab member arranging step, as shown in FIG. 11A, a pair of tab members T are arranged at both ends of the butted portion J4. The tab member T is in a rectangular parallelepiped shape and is formed of the same material as the first and second metal members 101A, 102A. The thickness of the tab member T is formed to be the same as the height of the outer end faces 101d, 102d. In the tab member arranging step, the side face of the tab member T is brought into contact with the side faces of the first and second metal members 101A, 102A to temporarily weld the inner corner between the first metal member 101A and the tab member T and the inner corner between the second metal member 102A and the tab member T. A front face Ta of the tab member T is made flush with the bottom face 110a of the recessed groove 110, and a rear face Tb of the tab member T is made flush with the bottom face 111a of the recessed groove 111.

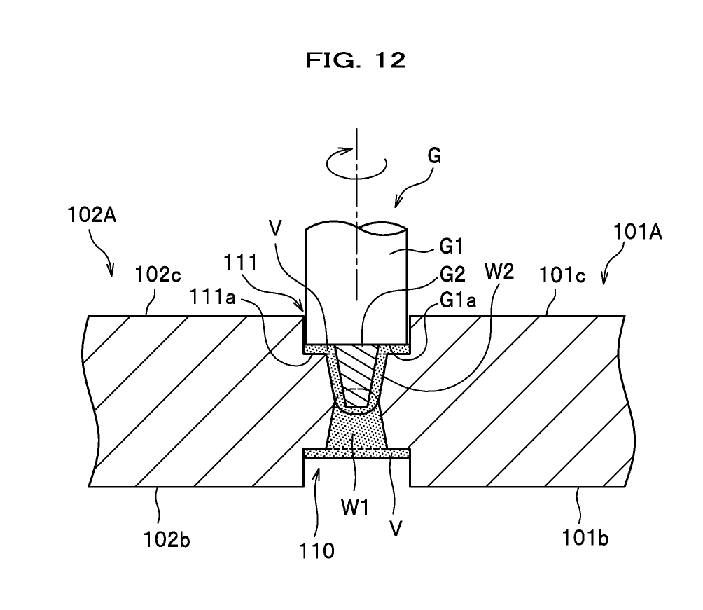

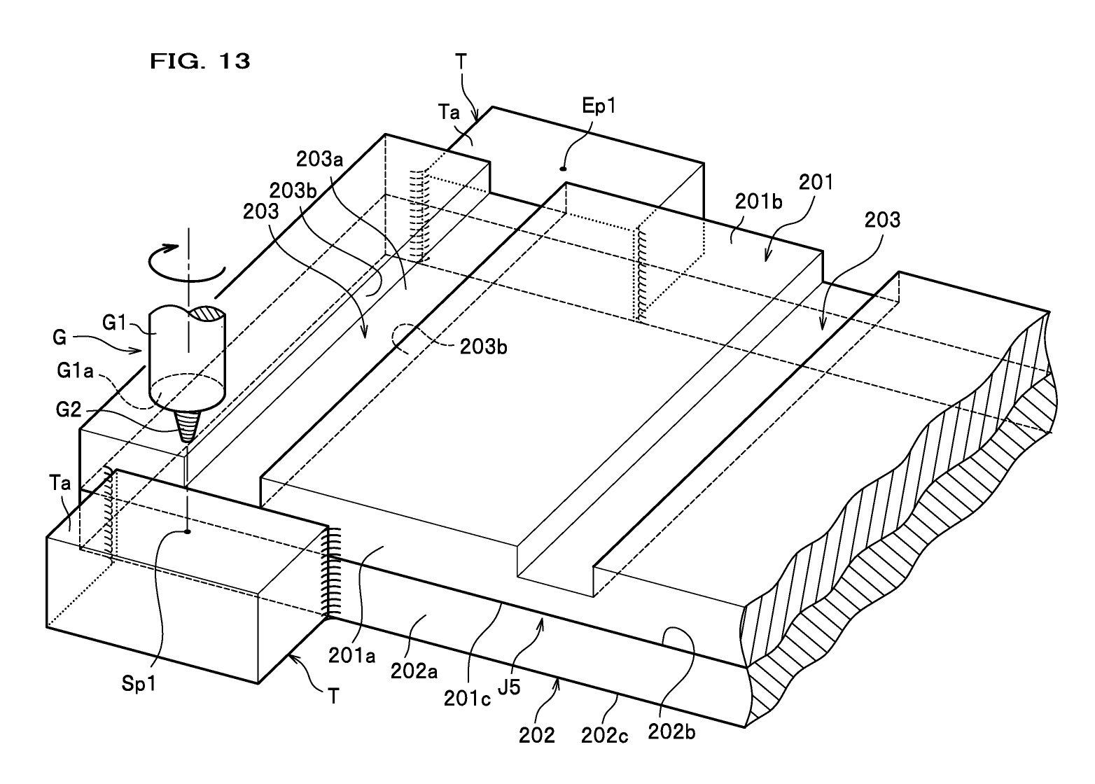

In the first friction stir step, as shown in FIGS. 11A and 11B, the rotary tool G is inserted in the recessed groove 110 to join the butted portion J4 by friction stir as in the same manner as the friction stir step in the first embodiment. A plasticized region W1 is formed on a movement track of the rotary tool G. In the second friction stir step, as shown in FIG. 12, the first and second metal members 101A, 102A are turned upside down, to insert the rotary tool G in the recessed groove 111 for joining the butted portion J4 by friction stir.

In the second friction stir step, the rotary tool G is inserted in a start position set in a rear face Tb of one tab member T and is relatively moved toward the first and second metal members 101A, 102A. When the rotary tool G comes to the butted portion J4, as shown in FIG. 12, the rotary tool G is relatively moved along the butted portion J4 (recessed groove 111) while the lower end face G1a is spaced from the bottom face 111a of the recessed groove 111. A plasticized region W2 is formed on the movement track of the rotary tool G.

In the second friction stir step, the lower end face G1a of the shoulder portion G1 is spaced from the bottom face 111a of the recessed groove 111, and is set at a position lower than the rear face 101c of the first metal member 101A. That is, in the second friction stir step, friction stir joining is carried out while the lower end face G1a of the shoulder portion G1 holds the burrs V generated by friction stir. Further, the second friction stir step is the same as the first friction stir step, except that the insertion depth is adjusted for the stirring pin G2 of the rotary tool G so as to reach the plasticized region W1 formed in the first friction stir step.

According to the joining method of the present embodiment described above, since the small space is defined by the bottom face 110a of the recessed groove 110, the side walls 110b of the recessed groove 110 and the lower end face G1a of the shoulder portion G1 during the first friction stir step, the burrs V are prevented from scattering and are deposited on the bottom face 110a of the recessed groove 110. This prevents the burrs V from being generated on the front face 101b of the first metal member 101A and the front face 102b of the second metal member 102A.

Further, the small space is defined by the bottom face 111a of the recessed groove 111, the side walls 111b of the recessed groove 111 and the lower end face G1a of the shoulder portion G1 during the second friction stir step, to prevent the burrs V from scattering and to allow the burrs V to be deposited on the bottom face 111a of the recessed groove 111. This prevents the burrs V from being generated on the rear face 101c of the first metal member 101A and the rear face 102c of the second metal member 102A. Accordingly, a surface treatment such as a burr removing step for the first and second metal members 101A, 102A is omitted.

Further, according to the joining method of the present embodiment, since the shoulder portion G1 is not pressed against the bottom face 110a of the recessed groove 110 and the bottom face 111a of the recessed groove 111, a load applied on the friction stir device is reduced. Still further, the butted portion J4 is frictionally stirred over the entire length in the depth direction by overlapping the plasticized region W1 formed in the first friction stir step with the plasticized region W2 formed in the second friction stir step. This improves joining strength, water-tightness and air-tightness. Yet further, since the height of the tab members T is formed to be as the same as the thickness of the outer end faces 101d, 102d, the tab members T are used in both the first and second friction stir steps.

### Fifth Embodiment

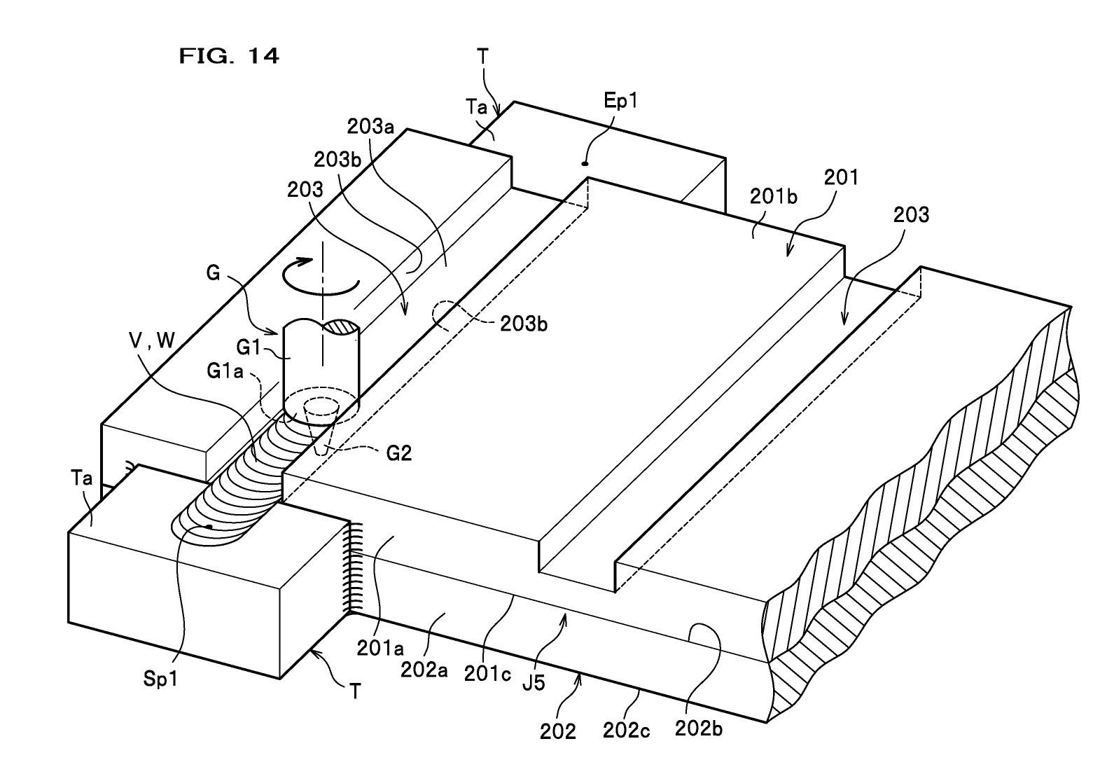

A description will be given of a joining method according to a fifth embodiment of the present invention in detail with reference to the drawings. As shown in FIG. 13, in the joining method according to the fifth embodiment, a first metal member 201 is overlaid on a second metal member 202 for joining. The joining method according to the fifth embodiment includes an overlaying step, a tab member arranging step and a friction stir step.

The first metal member 201 is a plate-shaped metal member. The material of the first metal member 201 is appropriately selected from frictionally stirrable metals such as aluminum, aluminum alloy, copper, copper alloy, titanium, titanium alloy, magnesium, and magnesium alloy. Recessed grooves 203 having a cross-sectionally rectangular shape are formed in a front face 201b of the first metal member 201. The recessed groove 203 extends in an extending direction of the first metal member 201. The recessed groove 203 is defined by a bottom face 203a and side walls 203b extending upward from the bottom face 203a.

The second metal member 202 is a plate-shaped metal member. The material of the second metal member 202 may be appropriately selected from the above-mentioned friction stirrable metals, and is preferably the same material as that of the first metal member 201. The second metal member 202 has the same shape as the first metal member 201, but may have a different shape. Further, both the first and second metal members 201, 202 are in a plate shape (rectangular parallelepiped shape), but may be in another polygonal, cylindrical or ellipsoidal shape in planar view.

In the overlaying step, as shown in FIG. 13, a rear face 201c of the first metal member 201 is overlaid on a front face 202b of the second metal member 202. An overlaid portion J5 is formed by overlaying the rear face 201c of the first metal member 201 on the front face 202b of the second metal member 202.

In the tab member arranging step, tab members T are arranged as shown in FIG. 13. The tab member T is in a rectangular parallelepiped shape. The tab member T is temporarily welded on end faces 201a, 202a of the first and second metal members 201, 202 so that the front face Ta of the tab member T is made flush with the bottom face 203a of the recessed groove 203.

In the friction stir step, as shown in FIGS. 13 and 14, the shoulder portion G1 of the rotary tool G is inserted in the recessed groove 203 to join the overlaid portion J5 by friction stir. The rotary tool G has the shoulder portion G1 in a cylindrical shape and the stirring pin G2 extending downward from the lower end face G1a of the shoulder portion G1. The diameter of the shoulder portion G1 is formed to be slightly smaller than the width of the recessed groove 203. The diameter of the shoulder portion G1 may be set such that the outer peripheral face of the shoulder portion G1 is in contact with the side walls 203b of the recessed groove 203. However, the diameter of the shoulder portion G1 is preferably set such that, during the friction stir step, the rotary tool G is relatively movable with a small gap between the outer peripheral face of the shoulder portion G1 and the side walls 203b of the recessed groove 203.

The stirring pin G2 is tapered. The spiral groove is formed on the outer peripheral face of the stirring pin G2. In the present embodiment, since the rotary tool G is rotated clockwise, the spiral groove of the stirring pin G2 is formed counterclockwise from the base end toward the distal end. In other words, the spiral groove is traced from the base end toward the distal end to find that it is formed counterclockwise as seen from above.

Note that, in a case where the rotary tool G is rotated counterclockwise, the spiral groove is preferably formed clockwise from the base end toward the distal end. In other words, the spiral groove in this case is traced from the base end toward the distal end to find that it is formed clockwise as seen from above. The spiral groove formed in this way allows a plastically fluidized metal to be guided toward the distal end of the stirring pin G2 via the spiral groove during the friction stir step. This reduces the amount of metal spilling out of the bottom face 203a of the recessed groove 203.

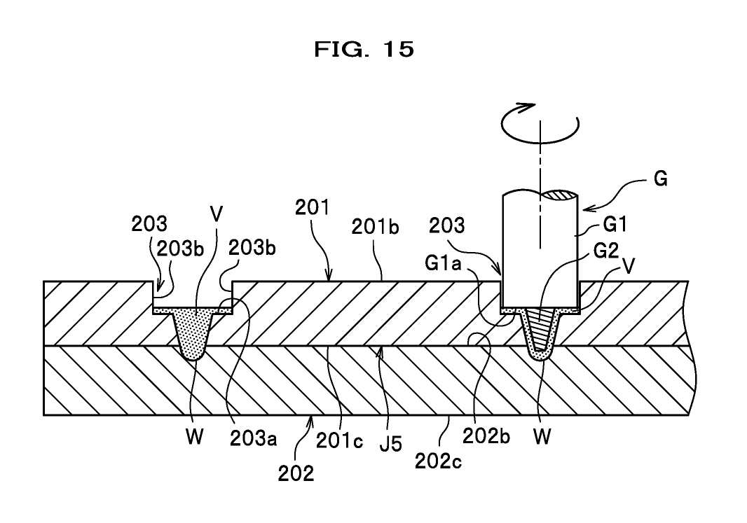

In the friction stir step, the stirring pin G2 of the rotary tool G is inserted in a start position Sp1 set in the front face Ta of one tab member T, and the rotary tool G is relatively moved to an end position Ep1 set in the front face Ta of the other tab member T along the overlaid portion J5 (recessed groove 203). The insertion depth may be appropriately set for the rotary tool G, but in the present embodiment, as shown in FIG. 15, is set such that the stirring pin G2 reaches the second metal member 202. Accordingly, the friction stir joining is carried out in a state that the stirring pin G2 contacts the first and second metal members 201, 202. A plasticized region W is formed on a movement track of the rotary tool G.

Further, in the friction stir step, as shown in FIG. 15, the lower end face G1a of the shoulder portion G1 is spaced from the bottom face 203a of the recessed groove 203 and is set at a position lower than the front face 201b of the first metal member 201. That is, in the friction stir step, the friction stir joining is carried out while the burrs V generated by friction stir is held under the lower end face G1a of the shoulder portion G1. The phrase in the appended claims, “a state that the shoulder portion is spaced from a bottom face of the recessed groove” means that the lower end face G1a of the shoulder portion G1 is spaced from the bottom face 203a of the recessed groove 203 before the burrs V are generated. Further, the phrase in the appended claims, “while the shoulder portion holds a burr generated from the first metal member” means that the lower end face G1a of the shoulder portion G1 is in contact with the deposited burrs V to hold the front face (upper face) of the burrs V under the lower end face G1a of the shoulder portion G1.

Further, the outer peripheral face of the shoulder portion G1 is spaced from the side walls 203b of the recessed groove 203 by the small gap. A small space is defined by the bottom face 203a of the recessed groove 203, the side walls 203b of the recessed groove 203, and the lower end face G1a of the shoulder portion G1.

Note that the stirring pin G2 may be set so as not to reach the second metal member 202. That is, in the friction stir step, the insertion depth may be set for the stirring pin G2 such that the stirring pin G2 only contacts the first metal member 201. Thus, in the case where the tip of the stirring pin G2 is set so as not to reach the second metal member 202, friction heat between the first metal member 201 and the stirring pin G2 plastically fluidizes the metal around the overlaid portion J5 to join the first metal member 201 with the second metal member 202.

Though the burrs V are generated on the bottom face 203a of the recessed groove 203 in the friction stir step, the burrs V are confined in the small space (rectangular closed space in cross-section) defined by the bottom face 203a of the recessed groove 203, the side walls 203b, 203b of the recessed groove 203 and the lower end face G1a of the shoulder portion G1, and the burrs V are deposited on the bottom face 203a. As shown in FIG. 15, the burrs V are deposited in the recessed groove 203 and the front face (upper face) of the burrs V is made approximately flat under the lower end face G1a of the shoulder portion G1. Once the rotary tool G reaches the end position Ep1, the rotary tool G is set apart from the tab member T and the tab members T are cut off.

According to the joining method of the present embodiment described above, since the small space is defined by the bottom face 203a of the recessed groove 203, the side walls 203b of the recessed groove 203 and the lower end face G1a of the shoulder portion G1 during the friction stir step, the burrs V are prevented from scattering and are deposited on the bottom face 203a of the recessed groove 203. This prevents the burrs V from being generated on the front face 201b of the first metal member 201. Accordingly, a surface treatment such as a burr removing step for the front face 201b of the first metal member 201 is omitted.

Further, according to the joining method of the present embodiment, since the shoulder portion G1 is not pressed against the bottom face 203a of the recessed groove 203, a load applied on the friction stir device is reduced. Note that, before the friction stir step, a temporary joining step may be carried out for the overlaid portion J5 from the end face 201a of the first metal member 201 and the end face 202a of the second metal member 202. In this case, for example, a small-sized rotary tool for temporary joining is used for joining the overlaid portion J5 temporarily. The temporary joining step may be carried out by welding. With the temporary joining step, in the friction stir step with the use of the rotary tool G, the first and second metal members 201, 202 are appropriately positioned for an operator to work steadily.

### Sixth Embodiment

Next, a description will be given of a joining method according to a sixth embodiment of the present invention. The joining method according to the present embodiment includes an overlaying step and a friction stir step. The joining method according to the present embodiment differs from the first embodiment in that a tab member arranging step is omitted and a recessed groove 303 is in a closed loop. Differences from the fifth embodiment will be mainly described for the joining method according to the sixth embodiment.

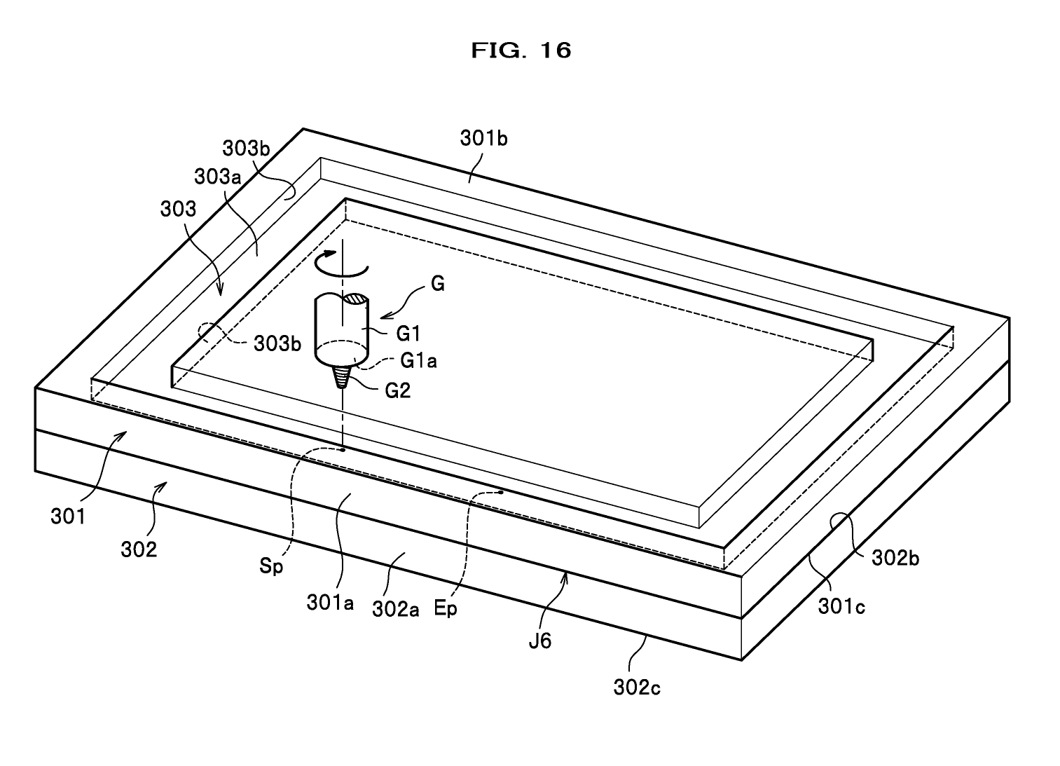

As shown in FIG. 16, a first metal member 301 is a plate-shaped metal member. The recessed groove 303 in a closed loop is formed on a front face 301b of the first metal member 301. Being in a closed loop means that the recessed groove 303 is closed so as to be circular. The planar shape of the recessed groove 303 may take any shape as long as it is closed, but in the present embodiment, is formed in a rectangular frame shape in a plan view along the periphery of the first metal member 301.

A second metal member 302 is a plate-shaped metal member. The planar cross-section of the second metal member 302 has the same shape as that of the first metal member 301, but may have a different shape. Further, the first and second metal members 301, 302 are in a plate shape (rectangular parallelepiped shape) in the present embodiment, but may be in another polygonal, cylindrical or ellipsoidal shape in planar view. Still further, a groove or a concave portion may be formed on the front face 302b of the second metal member 302. The groove or the concave portion is preferably formed inside the recessed groove 303 of the first metal member 301 in a plan view.

In the overlaying step, as shown in FIG. 16, a rear face 301c of the first metal member 301 is overlaid on a front face 302b of the second metal member 302. An overlaid portion J6 is formed by overlaying the rear face 301c of the first metal member 301 on the front face 302b of the second metal member 302.

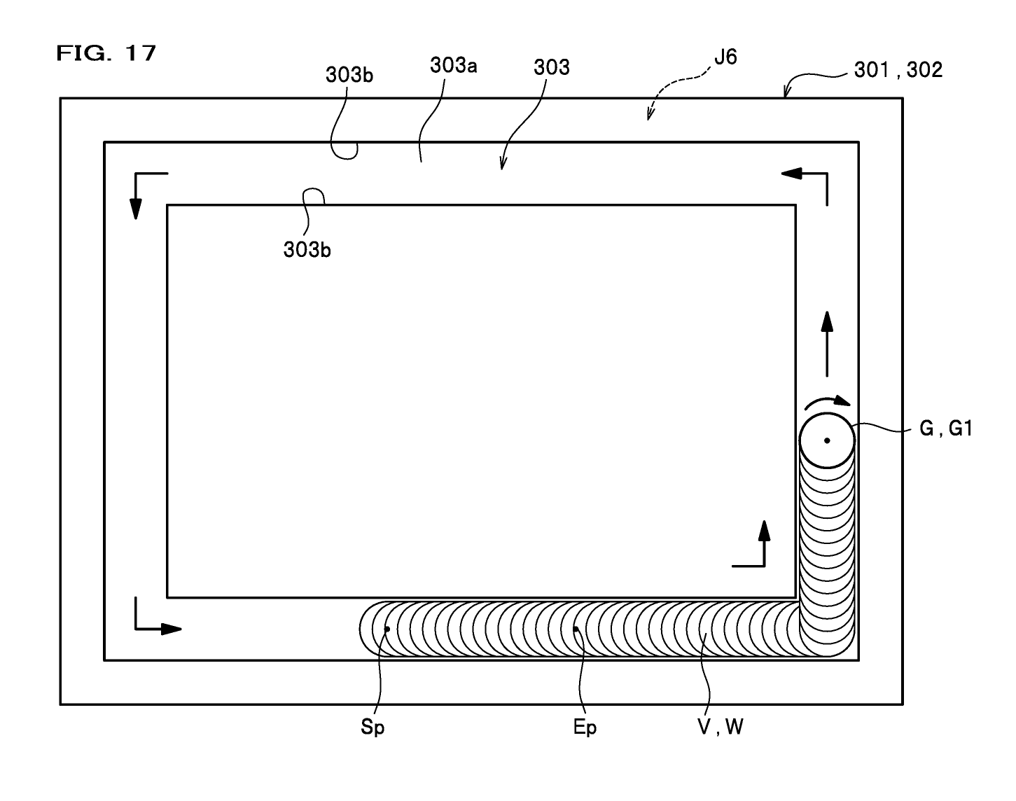

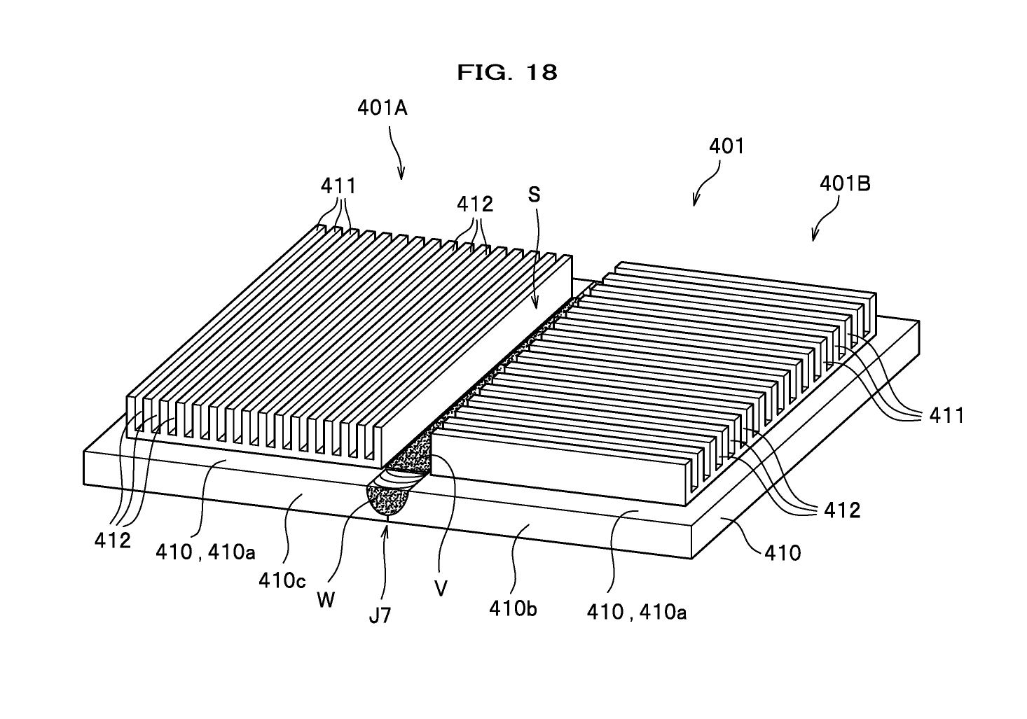

In the friction stir step, as shown in FIGS. 16 and 17, the shoulder portion G1 of the rotary tool G is inserted in the recessed groove 303 to join the overlaid portion J6 by friction stir. In the friction stir step, the stirring pin G2 of the rotary tool G is inserted in a start position Sp set in the recessed groove 303, and the overlaid portion J6 is joined along the recessed groove 303. A plasticized region W is formed on a movement track of the rotary tool G. A description on the insertion depth of the stirring pin G2 and holding the burrs V under the lower end face G1a of the shoulder portion G1 is the same as that described in the fifth embodiment.

After the rotary tool G is moved along the entire recessed groove 303, the rotary tool is further moved to the end position Ep set in the recessed groove 303 where the rotary tool G is set apart from the first metal member 301, to overlap the plasticized region W between the beginning and the ending.

According to the joining method of the present embodiment described above, since the small space is defined by the bottom face 303a of the recessed groove 303, the side walls 303b of the recessed groove 303 and the lower end face G1a of the shoulder portion G1 during the friction stir step, the burrs V are prevented from scattering and are deposited on the bottom face 303a of the recessed groove 303. Thus, the burrs V are prevented from being generated on the front face 301b of the first metal member 301. Accordingly, a surface treatment such as a burr removing step for the front face 301b of the first metal member 301 is omitted. The overlaid portion J6 is joined by friction stir along the recessed groove 303 in a closed loop, to improve joining strength. Further, the closed area is formed inside the recessed groove 303 in a closed loop.

Further, according to the joining method of the present embodiment, since the shoulder portion G1 is not pressed against the bottom face 303a of the recessed groove 303, a load applied on the friction stir device is reduced. Note that, before the friction stir step, a temporary joining step may be carried out on the overlaid portion J6 from the end faces 301a, 302a of the first and second metal members 301, 302. Still further, in the present embodiment, the rotary tool G is set apart from the first metal member 301 at the end position Ep set in the recessed groove 303. However, the rotary tool G may gradually be set apart from the first metal member 301 while being moved in the recessed groove 303. Yet further, in the friction stir step, the rotary tool G may not be moved along the entire recessed groove 303 in a closed loop (the plasticized region W is not overlapped between the beginning and the ending).

### Seventh Embodiment

Next, a description will be given of a heat sink and a method for manufacturing a heat sink according to a seventh embodiment of the invention. As shown in FIG. 18, a heat sink 401 according to the present embodiment is formed by joining a heat sink piece 401A with a heat sink piece 401B by friction stir.

The heat sink piece 401A has a plate-shaped base member 410 and a plurality of fins 411 arranged in parallel with each other on a front face 410a of the base member 410. Grooves 412 are formed between adjacent fins 411, 411. A fluid such as air or liquid flows through the grooves 412. The heat sink piece 401B is the same as the heat sink piece 401A, except for the orientation of the fins 411 of the heat sink piece 401A. The orientation of the fins 411 of the heat sink piece 401A is arranged to be orthogonal to the orientation of the fins 411 of the heat sink piece 401B.

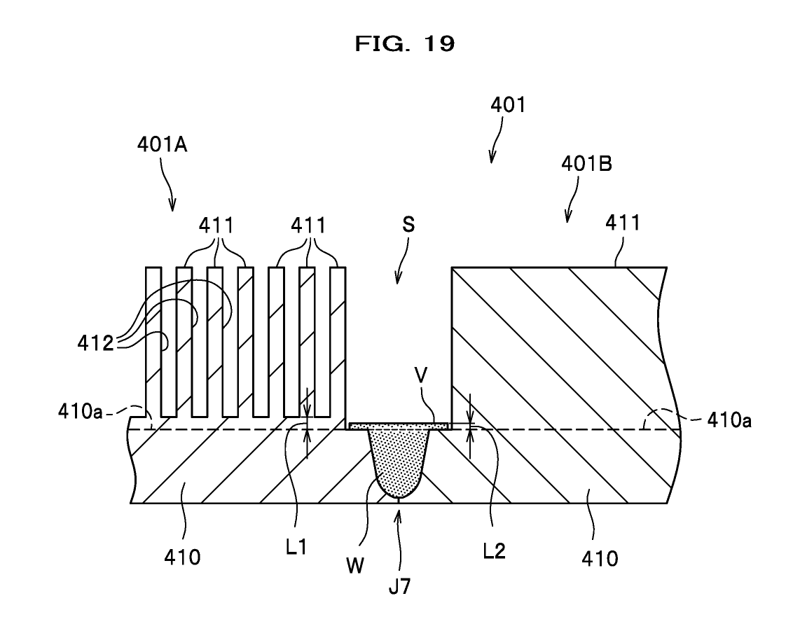

As shown in FIG. 19, a butted portion J7 between the heat sink piece 401A and the heat sink piece 401B is joined at a plasticized region W. Further, burrs V are deposited on the plasticized region W. That is, the burrs V are deposited along the butted portion J7 in a space S formed between the groups of fins 411 of the heat sink piece 401A and the groups of fins 411 of the heat sink piece 401B.

Next, a description will be given of the method for manufacturing a heat sink according to the present embodiment. The method for manufacturing a heat sink includes a grooving step, a butting step, a tab member arranging step and a friction stir step.

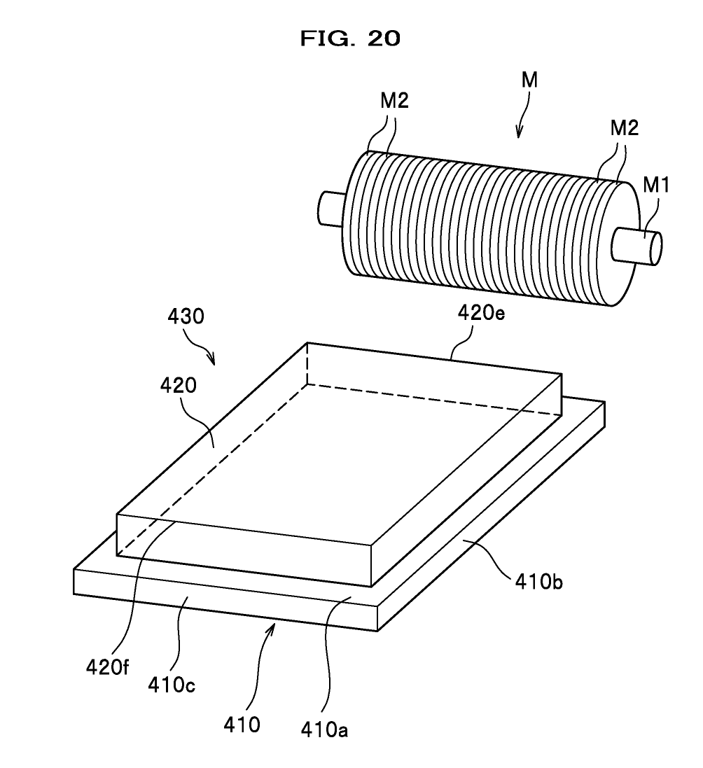

In the grooving step, as shown in FIG. 20, a machined metal member 430 is cut by a multi-cutter to form the heat sink piece 401A (401B). The machined metal member 430 has a base member 410 in a plate shape and a machined block 420 arranged on a front face 410a of the base member 410. The machined block 420 is in a rectangular parallelepiped shape. The machined block 420 is formed substantially on the center of the base member 410. The machined metal member 430 is preferably a metal having a high thermal conductivity, and in the present embodiment, is formed of aluminum alloy or aluminum.

The multi-cutter M includes a shaft M1 and a plurality of disc cutters M2 arranged in parallel on the shaft M1 at intervals. A blade portion (not shown) is formed on the periphery of the disc cutter M2. The multi-cutter M is a rotary tool that cuts the machined block 420 to form the fins 411 and grooves 412.

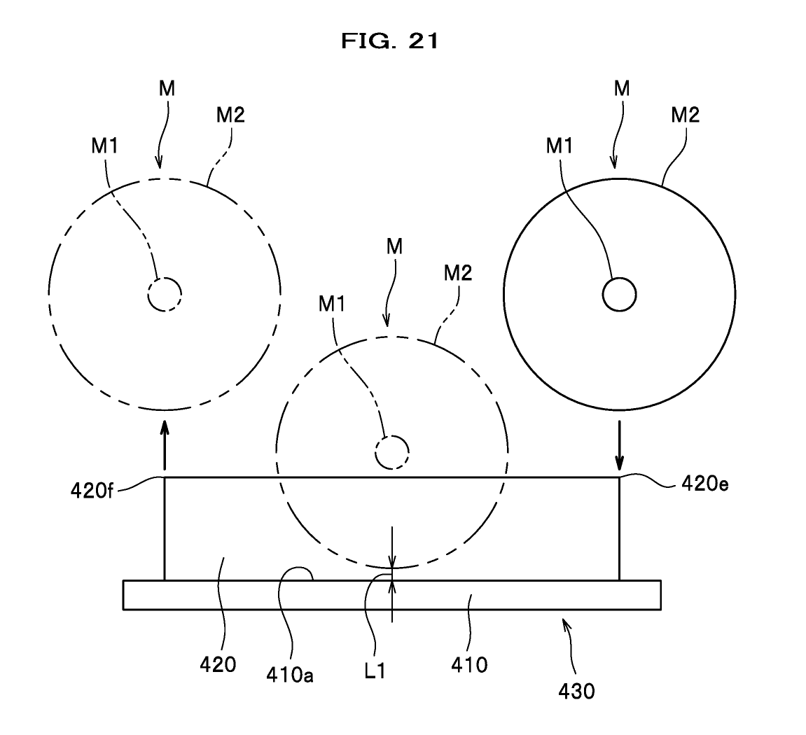

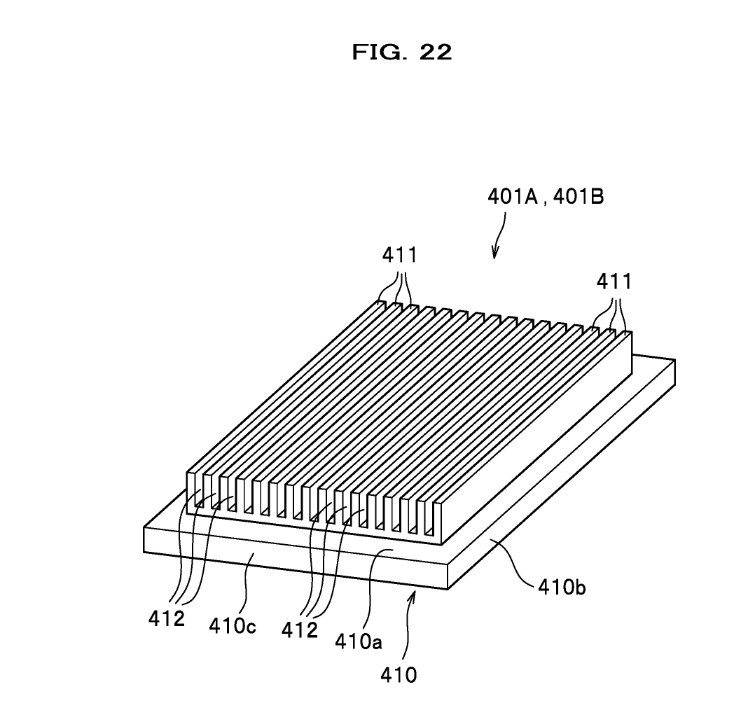

In the grooving step, as shown in FIG. 21, the shaft M1 of the multi-cutter M is arranged directly above one edge 420e of the machined block 420, and is moved downward, with the disc cutters M2 being rotated. Then, upon reaching a predetermined depth, the multi-cutter M is relatively moved at a constant height toward the other edge 420f. When the shaft M1 reaches the other edge 420f, the multi-cutter M is moved upward so as to be set apart from the machined block 420.

The insertion depth of the disc cutters M2 may be set appropriately, and in the present embodiment, is set to have a distance L1 between the front face 410a of the base member 410 and the outer periphery of the disc cutters M2. That is, the distance from the bottom face of the groove 412 to the front face 410a of the base member 410 is the distance L1. Thus, as shown in FIG. 22, the heat sink piece 401A is prepared in which the fins 411 and the grooves 412 are formed. Further, as in the same manner, the heat sink piece 401B is prepared.

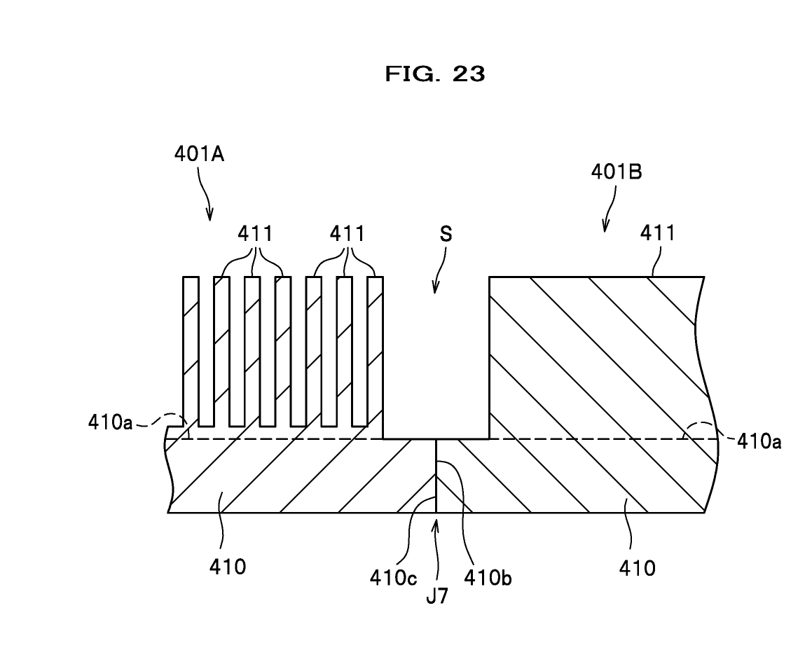

In the butting step, as shown in FIG. 23, the heat sink piece 401A is butted against the heat sink piece 401B. In the butting step, a lateral end face 410b of the heat sink piece 401A is butted against a lateral end face 410c of the heat sink piece 401B to form a butted portion J7, while the orientations of the fins 411 of the heat sink pieces 401A, 401B are orthogonal to each other. Further, in the butting step, front faces 410a of the base members 410 are butted against each other so as to be flush.

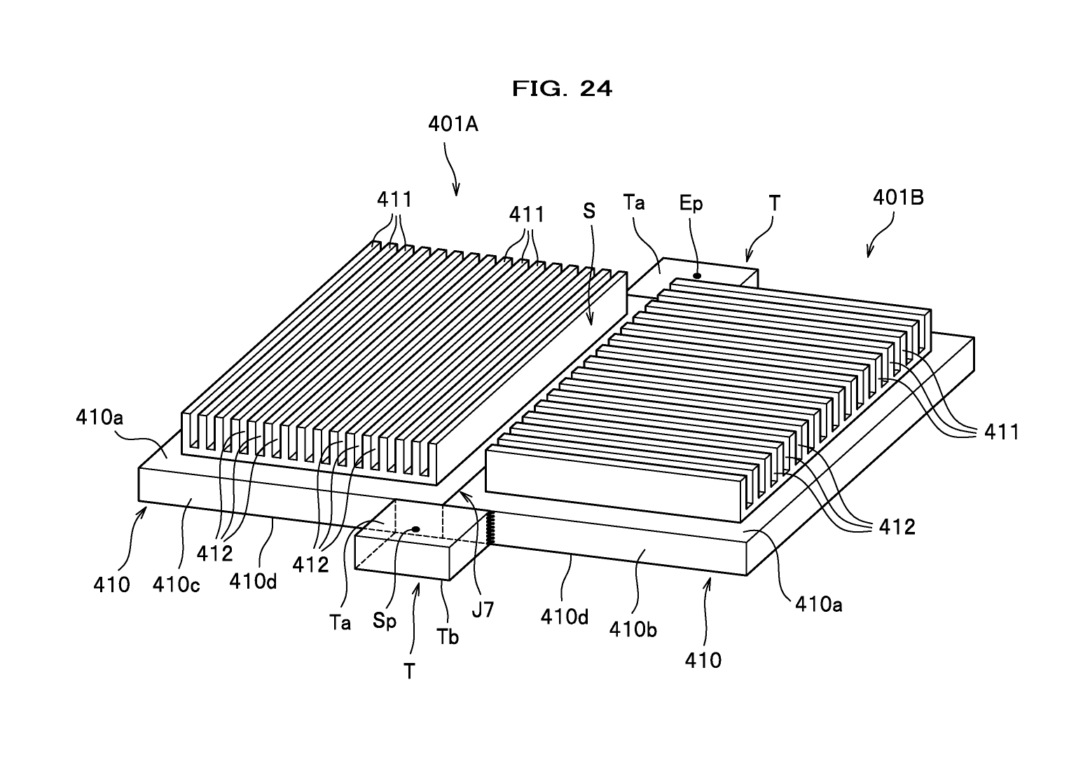

In the tab member arranging step, as shown in FIG. 24, a pair of tab members T are arranged at both ends of the butted portion J7. The tab member T is in a rectangular parallelepiped shape and is formed of the same material as the heat sink piece 401A. In the tab member arranging step, a side end face of the tab member T is butted against the lateral end faces 410b, 410c of the heat sink pieces 401A, 401B and the inner corners are temporarily welded. A front face Ta and a rear face Tb of the tab member T are arranged so as to be respectively flush with the front faces 410a and rear faces 410d of the base members 410.

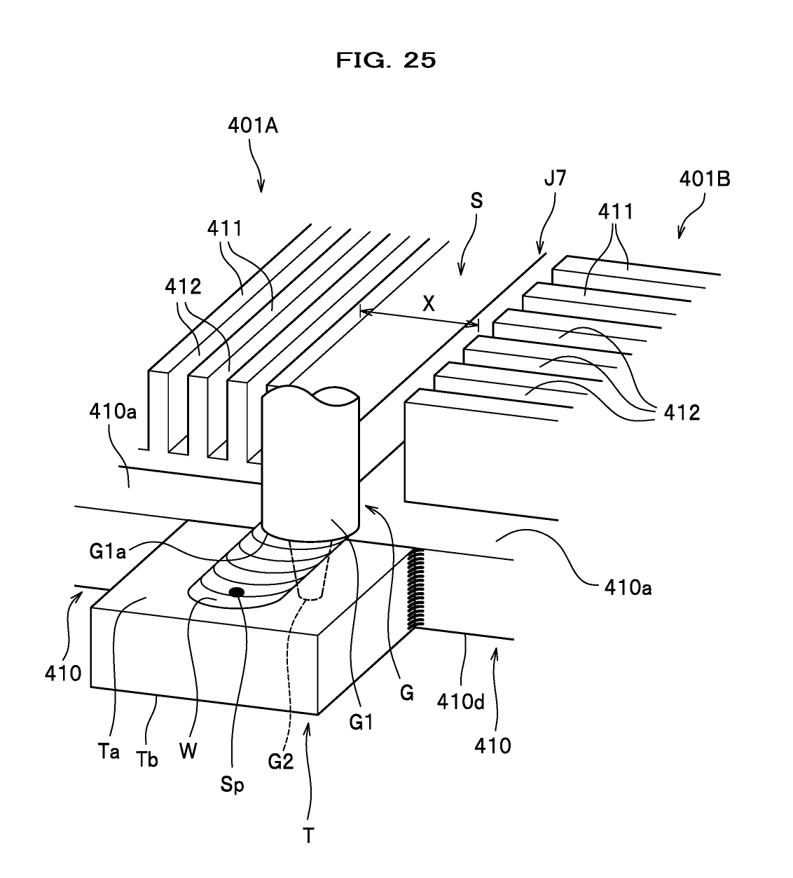

In the friction stir step, as shown in FIG. 25, the butted portion J7 is joined by friction stir with the use of a rotary tool G. The rotary tool G has a shoulder portion G1 and a stirring pin G2. The shoulder portion G1 is in a cylindrical shape. The stirring pin G2 extends downward from a lower end face G1a of the shoulder portion G1 so as to be tapered. A spiral groove (not shown) is formed on the outer peripheral face of the stirring pin G2. The diameter of the shoulder portion G1 is set to be smaller than a width X of the space S that is defined between the groups of fins 411 of the heat sink pieces 401A and the groups of fins 411 of the heat sink pieces 401B. In other words, the diameter of the shoulder portion G1 is set such that the rotary tool G is relatively movable in the space S.

In the friction stir step, as shown in FIG. 24, the rotary tool G is inserted in a start position Sp set in the front face Ta of one tab member T so as to be relatively moved along the butted portion J7, and the rotary tool G is set apart at an end position Ep set in the front face Ta of the other tab member T. Specifically, as shown in FIG. 25, the rotating stirring pin G2 is inserted in the start position Sp set in the front face Ta of the tab member T and a lower end face G1a of the shoulder portion G1 is pressed against the front face Ta. Then, the rotary tool G is relatively moved toward the butted portion J7. A plasticized region W is formed on a movement track of the rotary tool G.

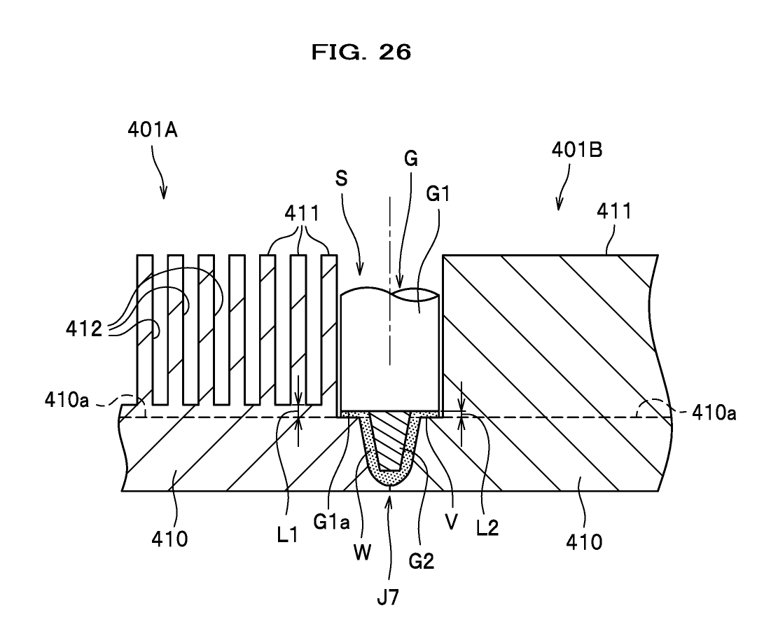

When the rotary tool G is relatively moved along the butted portion J7 and reaches the space S, the lower end face G1a of the shoulder portion G1 is separated from the front faces 410a of the base members 410. As shown in FIG. 26, in the space S, the lower end face G1a of the shoulder portion G1 is separated from the front faces 410a of the base members 410, to hold the burrs V generated by the friction stir under the lower end face G1a of the shoulder portion G1. Accordingly, the burrs V are deposited on the plasticized region W. The deposited burrs V are held under the lower end face G1a of the shoulder portion G1 to be substantially flat. A distance L2 (thickness of the burrs V) from the front faces 410a of the base members 410 to the lower end face G1a of the shoulder portion G1 may be set appropriately. In the present embodiment, the distance L2 is set to be smaller than the distance L1 (distance from the bottom face of the groove 412 to the front faces 410a of the base members 410).

When the rotary tool G passes over the space S, the rotary tool G is relatively moved while the lower end face G1a is pressed against the front faces 410a of the base members 410 again. Then, when the rotary tool G reaches the end position Ep, the rotary tool G is separated from the other tab member T.

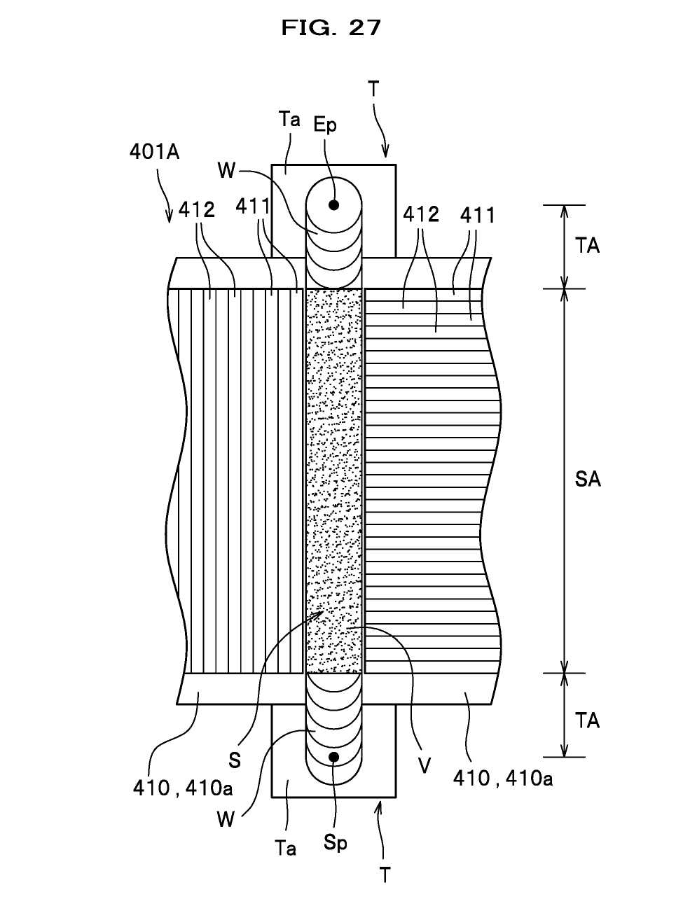

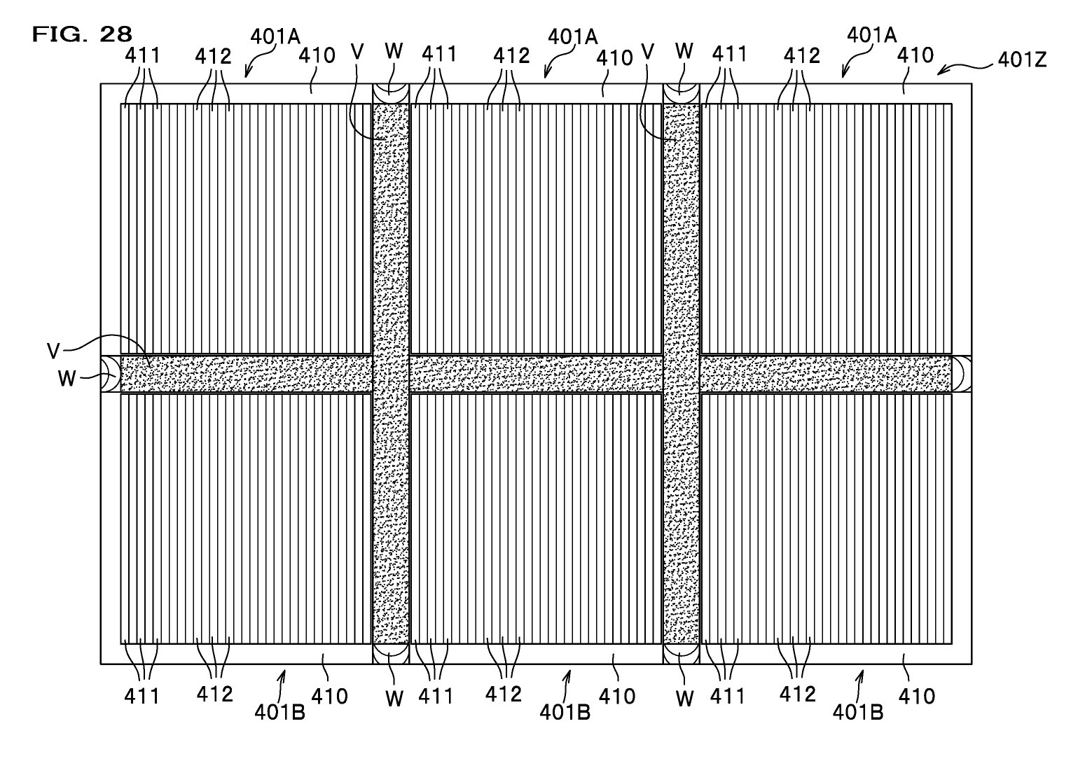

As shown in FIG. 27, in the friction stir step, in a region SA of the space S (space between the groups of fins 411 that are facing to each other), the friction stir is carried out by spacing the lower end face G1a of the shoulder portion G1 from the front faces 410a of the base members 410. In other regions TA (between the start position Sp and the space S and between the end position Ep and the space S), the friction stir is carried out by pressing the lower end face G1a of the shoulder portion G1 against the front face 410a of the base member 410. That is, in the regions TA corresponding to both ends of the butted portion J7, the pressed lower end face G1a of the shoulder portion G1 against the front face 410a prevents the burrs V from spilling outside. After the friction stir step, the tab members T are removed. With these steps, the heat sink 401 showed in FIG. 18 is manufactured.

According to the method for manufacturing a heat sink according to the present embodiment described above, as shown in FIG. 26, in the friction stir step, since the small space is defined by the fins 411 formed on both sides of the butted portion J7 and the lower end face G1a of the shoulder portion G1, the burrs V are prevented from scattering and are deposited on the front faces 410a of the base members 410. Thus, it is possible to prevent the burrs V from blocking the flowing fluid in the space S. Further, since the burrs V are deposited on the front faces 410a to secure the flow channel, a burr removing step is omitted.

Further, in the space S, since the shoulder portion G1 of the rotary tool G is not pressed against the front faces 410a of the base members 410, a load applied on the friction stir device is reduced. Accordingly, even if the base members 410 are thick, it is possible to join by friction stir to a deep position without applying a large load on the friction stir device. Still further, since the plurality of fins 411 is formed with the multi-cutter M, the thickness of the fin 411, an interval and the like between the fins 411 are easily changed. In other words, the fins 411 and the grooves 412 having various dimensions are easily formed only by changing the thickness or interval of the disc cutters M2 in the multi-cutter M.

Yet further, as in the present embodiment, the distance L2 between the lower end face G1a of the shoulder portion G1 and the front face 410a of the base member 410 is set to be smaller than the distance L1 between the bottom face of the groove 412 and the front face 410a of the base member 410, to prevent the burrs V from blocking the flowing fluid. Moreover, as in the present embodiment, in the case where the fins 411 of the heat sink pieces 401A, 401B are arranged orthogonally to each other, when a burr removing step is carried out, the burrs may be scattered in each groove 412 of the heat sink piece 401B to block the flowing fluid. However, since the distance L2 is set to be smaller than the distance L1, the burrs V are prevented from scattering in each groove 412.

Also, as in the present embodiment, setting the start position Sp for friction stir on one tab member T and setting the end position Ep for friction stir on the other tab member T allows for joining the butted portion J7 over the entire length by friction stir and nicely finishing the lateral end faces 410b, 410c of the base members 410.

The embodiments of the present invention have been described above, but may be modified appropriately within the scope not departing from the spirit of the present invention. For example, in the present embodiment, the two heat sink pieces 401A, 401B are joined, but three or more heat sink pieces may be joined. At this time, the orientation of the fins on each heat sink piece may be appropriately set.

Further, for example, in a modification shown in FIG. 28, six heat sink pieces 401A, 401B in total are joined to form one heat sink 401Z. The orientation of the fins 411 on the heat sink pieces 401A, 401B according to the modification are all arranged in parallel to each other. Thus, only appropriately changing the orientation of the fins 411 on the heat sink pieces 401A, 401B easily increases the variation of the flow channel where the fluid flows. Note that the base member 410 may be formed to have an appropriate planar shape, but as in the modification, may be formed to have a square shape in planar view, to allow for changing the orientations of the fins 411 and for easily pressing the plurality of heat sink pieces 401A, 401B against each other.

### EXPLANATION OF REFERENCES

1 first metal member
1b front face
1c rear face
2 second metal member
2b front face
2c rear face
3 recessed groove
J butted portion
G rotary tool
G1 shoulder portion
G2 stirring pin
W plasticized region
401 heat sink
401A heat sink piece
401B heat sink piece
410 base member
410a front face
410b lateral end face
410c lateral end face
411 fin
412 groove
420 machined block
430 machined metal member
M multi-cutter
M1 shaft
M2 disc cutter
S space
T tab member
V burr

1. A joining method comprising:
butting a rear face of a first metal member in a plate shape having a recessed groove on a front face against an end face of a second metal member in a plate shape to form a butted portion; and
executing friction stir in which a stirring pin of a rotary tool is inserted in the recessed groove from a front face of the first metal member, and the rotary tool is relatively moved along the recessed groove to join the butted portion by friction stir,
wherein the rotary tool has a shoulder portion in a cylindrical shape and the stirring pin that extends downward from the shoulder portion, wherein a diameter of the shoulder portion is set to be smaller than a width of the recessed groove, and
in the friction stir, the shoulder portion of the rotary tool is inserted in the recessed groove, and the butted portion is joined by friction stir in a state that the shoulder portion is spaced from a bottom face of the recessed groove while the shoulder portion holds a burr generated from the first metal member.

2. The joining method according to claim 1, wherein a thickness of the second metal member is set to be larger than the width of the recessed groove.

3. A joining method of joining metal members to each other by friction stir comprising:
preparing end faces that face an opposed metal member, in which each end face is formed to have an outer end face that is formed on a rear side, an inner end face that is formed on a front side so as to be away from the metal member facing the outer end face, and an intermediate face that is connected with the outer end face and the inner end face;
butting the outer end faces of the metal members to form a butted portion so as to form a recessed groove that is formed with the intermediate faces and the inner end faces; and
executing friction stir in which a rotary tool is inserted from the front faces of the metal members to join the butted portion by friction stir,
wherein the rotary tool has a shoulder portion in a cylindrical shape and a stirring pin that extends downward from the shoulder portion, wherein a diameter of the shoulder portion is set to be smaller than a width of the recessed groove, and
in the friction stir, the shoulder portion of the rotary tool is inserted in the recessed groove, and the butted portion is joined by friction stir in a state that the shoulder portion is spaced from a bottom face of the recessed groove while the shoulder portion holds a burr generated from each metal member.

4. A joining method of joining metal members to each other by friction stir comprising:
preparing end faces that face an opposed metal member, in which each end face is formed to have an outer end face that is formed at a center in a thickness direction, a pair of inner end faces that is formed on a front side and a rear side with respect to the outer end face so as to be away from the metal member facing the outer end face, and a pair of intermediate faces that is connected with the outer end face and the pair of inner end faces respectively;
butting the outer end faces of the metal members against each other to form a butted portion so as to form a pair of recessed grooves that is formed with the intermediate faces and the inner end faces respectively formed on the front sides and the rear sides of the metal members;
executing first friction stir in which a rotary tool is inserted from the front faces of the metal members to join the butted portion by friction stir; and
executing second friction stir in which the rotary tool is inserted from the rear faces of the metal members to join the butted portion by friction stir,
wherein the rotary tool has a shoulder portion in a cylindrical shape and a stirring pin that extends downward from the shoulder portion, wherein a diameter of the shoulder portion is set to be smaller than a width of the recessed grooves, and
in the first friction stir and the second friction stir, the shoulder portion of the rotary tool is respectively inserted in the recessed grooves, and the butted portion is joined by friction stir in a state that the shoulder portion is spaced from bottom faces of the recessed grooves while the shoulder portion holds a burr generated from each metal member.

5. The joining method according to claim 4, wherein a plasticized region formed in the first friction stir is overlapped with that formed in the second friction stir.

6. The joining method according to claim 3 further comprising:
arranging tab members at both ends of the butted portion respectively,
wherein, in the friction stir, a start position for friction stir is set in one tab member and an end position for friction stir is set in the other tab member.

7. A joining method comprising:
overlaying a rear face of a first metal member having a recessed groove in a front face with a front face of a second metal member to form an overlaid portion; and
executing friction stir in which a stirring pin of a rotary tool is inserted in the recessed groove from a front side of the first metal member, and the rotary tool is relatively moved in the recessed groove to join the overlaid portion by friction stir,
wherein the rotary tool has a shoulder portion in a cylindrical shape and the stirring pin that extends downward from the shoulder portion, wherein a diameter of the shoulder portion is set to be smaller than a width of the recessed groove, and
in the friction stir, the shoulder portion of the rotary tool is inserted in the recessed groove, and the overlaid portion is joined by friction stir in a state that the shoulder portion is spaced from a bottom face of the recessed groove while the shoulder portion holds a burr generated from the first metal member.

8. A joining method comprising:
overlaying a rear face of a first metal member having a recessed groove in a front face with a front face of a second metal member to form an overlaid portion; and
executing friction stir in which a stirring pin of a rotary tool is inserted in the recessed groove from a front side of the first metal member, and the rotary tool is relatively moved in the recessed groove to join the overlaid portion by friction stir,
wherein the recessed groove is formed to be a closed loop,
the rotary tool has a shoulder portion in a cylindrical shape and the stirring pin that extends downward from the shoulder portion, wherein a diameter of the shoulder portion is set to be smaller than a width of the recessed groove, and
in the friction stir, the shoulder portion of the rotary tool is inserted in the recessed groove, and the overlaid portion is joined by friction stir in a state that the shoulder portion is spaced from a bottom face of the recessed groove while the shoulder portion holds a burr generated from the first metal member.

9. The joining method according to claim 8, wherein, in the friction stir, the rotary tool is moved along the entire recessed groove to join the overlaid portion by friction stir.

10. A method for manufacturing a heat sink comprising:
grooving in which a multi-cutter having a plurality of disc cutters in parallel is rotated to relatively move in a machined metal member having a base member and a machined block that is arranged on a front face of the base member and is in a rectangular parallelepiped shape to form a heat sink piece having a plurality of fins and grooves;
butting lateral end faces of the base members of at least two heat sink pieces against each other to form a butted portion; and
executing friction stir in which a rotary tool having a shoulder portion in a cylindrical shape and a stirring pin that extends downward from the shoulder portion is relatively moved along the butted portion to join the butted portion by friction stir,
wherein a diameter of the shoulder portion is set to be smaller than a width of a space between groups of fins of the adjacent heat sink pieces, and
in the friction stir, the stirring pin of the rotary tool is inserted in the butted portion, and the butted portion is joined by friction stir in a state that the shoulder portion is spaced from a front face of the base member while the shoulder portion holds a burr generated from the base member.

11. The method for manufacturing a heat sink according to claim 10, wherein, in the friction stir, a distance between the shoulder portion and the front face of the base member is set to be smaller than that between a bottom face of the groove and the front face of the base member.

12. The method for manufacturing a heat sink according to claim 10 further comprising:
arranging a pair of tab members at both ends of the butted portion,
wherein, in the friction stir, a start position for friction stir is set in one tab member and an end position for friction stir is set in the other tab member.

13. The method for manufacturing a heat sink according to claim 10, wherein, in the butting, the heat sink pieces are butted so that an orientation of the fins on one heat sink piece is in parallel to that of the fins on another heat sink piece.

14. The method for manufacturing a heat sink according to claim 10, wherein, in the butting, the heat sink pieces are butted so that an orientation of the fins on one heat sink piece is different from that of the fins on another heat sink piece.

15. A joining method comprising:
overlaying a rear face of a first metal member having a recessed groove in a front face with a front face of a second metal member to form an overlaid portion; and
executing friction stir in which a stirring pin of a rotary tool is inserted in the recessed groove from a front side of the first metal member, and the rotary tool is relatively moved in the recessed groove to join the overlaid portion by friction stir,
wherein the rotary tool has a shoulder portion in a cylindrical shape and the stirring pin that extends downward from the shoulder portion, wherein a diameter of the shoulder portion is set to be smaller than a width of the recessed groove, and
in the friction stir, the shoulder portion of the rotary tool is inserted in the recessed groove, and the overlaid portion is joined by friction stir in a state that the shoulder portion is spaced from a bottom face of the recessed groove while the shoulder portion holds a burr generated from the first metal member.

16. The joining method according to claim 15, wherein the diameter of the shoulder portion is set such that an outer peripheral face of the shoulder portion is in contact with side walls of the recessed groove.

17. The joining method according to claim 15, wherein the diameter of the shoulder portion is set such that, during the friction stir step, the rotary tool is relatively movable with a small gap between an outer peripheral face of the shoulder portion and side walls of the recessed groove.

18. The joining method according to claim 15, wherein a spiral groove is formed on an outer peripheral face of the stirring pin, and
wherein the rotary tool is rotated clockwise while the spiral groove of the stirring pin is formed counterclockwise from a base end of the stirring pin toward a distal end of the stirring pin, and the rotary tool is rotated counterclockwise while the spiral groove of the stirring pin is formed clockwise from the base end of the stirring pin toward the distal end of the stirring pin.

19. A joining method comprising:
overlaying a rear face of a first metal member having a recessed groove in a front face with a front face of a second metal member to form an overlaid portion; and
executing friction stir in which a stirring pin of a rotary tool is inserted in the recessed groove from a front side of the first metal member, and the rotary tool is relatively moved in the recessed groove to join the overlaid portion by friction stir,
wherein the recessed groove is formed to be a closed loop,
the rotary tool has a shoulder portion in a cylindrical shape and the stirring pin that extends downward from the shoulder portion, wherein a diameter of the shoulder portion is set to be smaller than a width of the recessed groove, and
in the friction stir, the shoulder portion of the rotary tool is inserted in the recessed groove, and the overlaid portion is joined by friction stir in a state that the shoulder portion is spaced from a bottom face of the recessed groove while the shoulder portion holds a burr generated from the first metal member.

20. The joining method according to claim 19, wherein, in the friction stir, the rotary tool is moved along the entire recessed groove to join the overlaid portion by friction stir.

21. The joining method according to claim 19, wherein a groove or a concave portion is formed on the front face of the second metal member, and the groove or the concave portion is formed inside the recessed groove of the first metal member in a plan view.

22. The joining method according to claim 19, wherein the diameter of the shoulder portion is set such that an outer peripheral face of the shoulder portion is in contact with side walls of the recessed groove.

23. The joining method according to claim 19, wherein the diameter of the shoulder portion is set such that, during the friction stir step, the rotary tool is relatively movable with a small gap between an outer peripheral face of the shoulder portion and side walls of the recessed groove.

24. The joining method according to claim 19, wherein a spiral groove is formed on an outer peripheral face of the stirring pin, and
wherein the rotary tool is rotated clockwise while the spiral groove of the stirring pin is formed counterclockwise from a base end of the stirring pin toward a distal end of the stirring pin, and the rotary tool is rotated counterclockwise while the spiral groove of the stirring pin is formed clockwise from the base end of the stirring pin toward the distal end of the stirring pin.
